(19) United States
(12) Patent Application Publication
(10) Pub. No.: US 2025/0328925 A1
(43) Pub. Date: Oct. 23, 2025

(54) METHOD OF AND SYSTEM FOR PERFORMING META-PREDICTIONS USING FORECASTING MODELS

(71) Applicant: RECHERCHES DIMENSIONNELLES CANADA INC., Sherbrooke (CA)

(72) Inventors: Jean-Marc Patenaude, Sherbrooke (CA); Kevin J. Chalifoux, Sainte-Thérèse (CA); Mathieu Lussier, Sainte-Catherine-de-Hatley (CA)

(21) Appl. No.: 18/986,110

(22) Filed: Dec. 18, 2024

Related U.S. Application Data
(60) Provisional application No. 63/612,198, filed on Dec. 19, 2023.

(51) Int. Cl. G06Q 30/0202

(52) U.S. Cl. CPC G06Q 30/0202

(57) ABSTRACT

There are provided methods, systems, and non-transitory storage mediums for performing a meta-prediction of time series by using a set of forecasting models each associated with a forecasting theme. Time series data is received, and a set of forecast signals is generated. At least one signal and feature processing model generates a set of features. A meta-learner having been trained on historical time series data generates, based on the time series data and the set of features, a set of weights for the set of forecasting models. A meta-prediction is generated by using the set of features and forecast signals. Implementations may use combinations of endogenous and exogenous data, latent space transformations and generate interpretations and explanations for the meta-prediction.

### CROSS-REFERENCE TO RELATED APPLICATIONS

The present application claims priority to U.S. Provisional Patent Application No. 63/612,198, which was filed on Dec. 19, 2023, the content of which is incorporated herein by reference in its entirety.

### FIELD

The present technology relates to machine learning and forecasting models in general and more specifically to methods, systems, and non-transitory storage mediums for performing meta-predictions for at least one time-series using dynamically selected forecast signals generated by a set of forecasting models.

### BACKGROUND

A time series is a sequence of data points collected or recorded at regular time intervals. Time series data is found across a wide range of fields, such as meteorology, which relies heavily on time series for historical weather data, which is fundamental in predicting future weather conditions. Environmental studies use time series to monitor changes in climate patterns, air quality, and water levels in hydrological studies. Healthcare industries maintain time series data related to disease incidence, patient outcomes over time, and the spread of infections. In the realm of engineering, time series analysis is employed for quality control and monitoring changes or trends in material fatigue over the lifecycle of a structure or machine. In economics, time series may track variables such as GDP, inflation rates, or employment figures over time. In finance, time series data is used to represent stock prices, trading volumes, and interest rate trends.

The forecasting of time series involves using historical data to predict future values. For instance, economists use time series forecasting to make informed projections about economic conditions, which can influence policy-making and economic planning. In the stock market, investors and analysts apply time series forecasting to make decisions about buying and selling stocks based on past performance trends. Retail businesses leverage time series forecasting for inventory management, predicting future product demand to optimize stock levels and reduce carrying costs. In the public sector, time series forecasting is used for urban planning, where it is used to project population growth, traffic patterns, and resource needs. Some of these applications utilizes various forecasting models, such as Autoregressive Integrated Moving Average (ARIMA), exponential smoothing, and seasonal decomposition, to analyze the data and extrapolate future trends from historical patterns. However, such forecasting model may only be applicable in specific scenarios.

Using weighted averages to combine forecasts has been proposed and used to mitigate the risk associated with choosing an incorrectly specified forecasting model.

### SUMMARY

It is an object of the present technology to ameliorate at least some of the inconveniences present in the prior art. One or more implementations of the present technology may provide and/or broaden the scope of approaches to and/or methods of achieving the aims and objects of the present technology.

One or more implementations of the present technology have been developed based on developers' appreciation that forecasting models are used as quantitative tools to predict future data points by analyzing historical trends in data, particularly with time series. Since the selection of forecasting models typically depends on specific characteristics of the data and the type of forecasting models, methods for obtaining weighted forecast combinations have been developed.

Developers have also appreciated that existing methods and techniques for performing weighted forecasts combinations may not necessarily take into account additional data that may provide useful information for generating features for performing forecasts and/or weighing the forecasts, such as exogenous data including exogenous time series, interactions between endogenous and exogenous time series, as well as alternative exogenous data. In this context, and given a time series to predict, endogenous data may include any mathematical transformation of said time series, whereas exogenous data may include any other transformation that includes non-endogenous data, including those involving said time series and other time series that are not related to said time series. For example, in the context of a financial asset and a time series that expresses a quantity related to said asset, economic activity, geographic indicators, geopolitical indicators, social media and other similar exogenous data may influence the time series behavior of said asset but may not be directly related to said asset. Similarly, in biological systems, the growth rate of a bacteria may be the time series of interest that we seek to predict, while exogenous time series data may include the varying temperature levels at different physical locations in the bacterial ecosystem, or the changing levels of various elements in its environment (such as oxygen levels, toxin levels, etc.). All these data may directly or indirectly affect the behavior of the time series of interest.

Developers have appreciated that providing features derived from endogenous data and exogenous data to a meta-learner could be used to improve the quality of the final forecast or meta-prediction dynamically.

Further, developer(s) have also appreciated that the complexity of known weighted forecast combinations methods may reduce the transparency of the process, making it difficult to interpret the forecast, understand how the forecast was derived and explain the drivers behind the final prediction.

Additionally, developer(s) have realized that combined forecasts could be associated with conviction scores, which could provide a sense of predictability on the quality of the forecast based on historical time series or forecasting data as well as historical weights and features used.

One or more implementations of the present technology enables improving performance of predictions based on time series, provide robustness to the meta-prediction process, which may in turn optimize computational resources and bandwidth.

One or more implementations of the present technology may provide users with a trust in said forecasts via a set of interpretation signals, including associations to previous similar situations and distribution of possible outcomes. As a non-limiting example, interpretability and explainability may be provided using clustering techniques on historical features and historical weights by grouping current meta-predictions according to the derived clusters and may additionally use large language models (LLMs) for providing interpretations and explanations to end users.

Thus, one or more implementations of the present technology are directed to a methods, systems and non-transitory storage mediums for performing meta-predictions using a set of forecasting models.

One or more implementations of the present technology may be used in the field of finance, where time series forecasting may be used to predict stock market movements or economic trends. Input variables may include historical stock prices, trading volumes, economic indicators, and company financials. Exogenous data may include, but may not be limited to, regulatory changes, macroeconomic factors, political events, or market sentiment. The output forecast signals may include future values or range predictions for stock prices or economic indices, which provide investors and policymakers with a probabilistic assessment to guide investment decisions and economic planning.

One or more implementations of the present technology may be used in the field of medicine, where time series forecasting may be used to predict disease outbreaks, patient admissions, or medical inventory requirements. Input variables may include historical patient admission rates, outbreak patterns of specific diseases, or usage rates of medical supplies. Exogenous data may include, but may not be limited to, factors such as public health policies, seasonal trends (e.g., flu seasons), or demographic shifts. The output forecast signals may include expected number of cases, admissions, or required supplies in the future, enabling healthcare providers and administrators to allocate resources effectively and plan preventive measures.

One or more implementations of the present technology may be used in the field of meteorology and climate modeling, where time series forecasting may be used to predict weather conditions and climate change. Input variables may include various parameters, including temperature readings, atmospheric pressure, humidity levels, wind patterns, and historical storm tracks. Exogenous data may include, but may not be limited to, factors such as ocean temperatures (which influence climate patterns), volcanic eruptions, or deforestation rates affecting local climates. The output forecast signals may include predictions about temperature, precipitation, storm events, and other weather phenomena that inform the public, help with agriculture planning, or aid disaster preparedness efforts.

One or more implementations of the present technology may be used in the field of ecology, where time series forecasting may be used to predict changes in ecosystems, animal populations, or the spread of invasive species. Input variables for such models may include for example population counts, migration patterns, and breeding rates. Exogenous data may include, but may not be limited to, climate change variables, human land use changes, and/or natural disasters. The output from these models helps in the management of wildlife reserves, framing of conservation policies, and understanding of ecological dynamics.

One or more implementations of the present technology may be used in the field of sociology, where time series forecasting may be used to understand and predict social trends, such as urbanization, migration, or crime rates. Inputs variables may include for example demographic data, economic statistics, urban development indexes, and past trends of the social phenomena under study. Exogenous data may include, but may not be limited to, policy changes, economic conditions, or major social events. The output forecast signals may include prediction about social behavior trends, demographic changes, or the potential impact of social policies, providing valuable insights for governments, urban planners, and social scientists.

One or more implementations of the present technology may be used in the field of computing, where time series forecasting may be used to predict future trends in computer system usage, service demands, and network traffic. Input variables may include for example historical data on system loads, CPU and GPU usage, memory utilization, user demand, and error rates. Exogenous data may include, but may not be limited to, expected software releases, updates, scheduled maintenance, technological advancements, or changes in user behavior due to external events. The output forecast signals may include predicted system load for capacity planning, anticipated data traffic for bandwidth allocation, and expected user demand to inform scaling strategies for cloud resources. It will be appreciated that in such implementations, forecasts enable maintaining system performance, ensuring user satisfaction, and guiding the expansion of computing infrastructure. Additionally, forecasting may aid pre-emptive scaling and in preparing for future requirements, thus ensuring that computing resources are neither underutilized due to over-provisioning nor overstrained by unexpected demand, thereby optimizing energy resources.

One or more implementations of the present technology may be used in the energy sector, where time series forecasting may enable ensuring efficient operation of energy grids and the effective distribution of power. Input variables may include for example historical consumption data, production levels from different energy sources, weather data influencing energy use, and pricing trends. Exogenous data may include, but may not be limited to, policy changes affecting energy consumption, introduction of energy-efficient technologies, shifts in industrial activity, and socio-economic trends that alter consumption patterns. The output forecast signals may include anticipated energy demands, potential production levels, and price forecasts. It will be appreciated that by accurately predicting supply and demand, energy providers can optimize the mix of renewable and non-renewable energy sources, reduce waste, and lower costs, contributing to more sustainable energy management practices.

In accordance with a broad aspect of the present technology, there is provided a method for performing a meta-prediction of time series associated with at least one asset by using a set of forecasting models, each forecasting model being associated with a respective forecasting theme. The method is executed by at least one processor operatively connected to at least one non-transitory storage medium, the at least one processor having access to the set of forecasting models. The method comprises: receiving, from the at least one non-transitory storage medium, time series data associated with at least one asset, generating, by using the set of forecasting models, based on the time series data, a set of forecast signals, each respective forecast signal of the set of forecast signals predicting at least one future value in the time series according to the respective forecasting theme, generating, by at least one signal and feature processing model, based on the time series data, a set of features, determining, by a trained meta-learner having been trained on historical time series data, based on the time series data and the set of features, a set of weights, the set of weights comprising a respective weight for each respective forecast signal of the set of forecast signals, the respective weight being indicative of a relative importance of the respective theme of the respective forecasting model, and generating, using the set of weights and the set of forecast signals, a meta-prediction.

In one or more implementations of the method, said generating, by at least one signal and feature processing model, based on the time series data, the set of features comprises: applying a latent space transformation on the time series data to obtain at least a subset of the set of features.

In one or more implementations of the method, said applying the latent space transformation on the time series data to obtain at least the subset of the set of features comprises generating a synthetic time series based on the time series data and extracting at least the subset of features therefrom.

In one or more implementations of the method, the time series data comprises a set of time series, and said generating, by the at least one signal and feature processing model, based on the time series data, the set of features comprises: determining interactions between a first time series and a second time series of the set of time series to obtain a further subset of features.

In accordance with a broad aspect of the present technology, there is provided a method for performing a meta-prediction of time series by using a set of forecasting models, each forecasting model being associated with a respective forecasting theme. The method is executed by at least one processor operatively connected to at least one non-transitory storage medium, the at least one processor having access to the set of forecasting models. The method comprises: receiving, from the at least one non-transitory storage medium, endogenous data comprising endogenous time series data associated with endogenous metadata, receiving, from the at least one non-transitory storage medium, exogenous data characterizing an environment of the time series, generating, by using the set of forecasting models, based on the endogenous and exogenous data, a set of forecast signals, each respective forecast signal of the set of forecast signals predicting at least one future value in the time series according to the respective forecasting theme, generating, by at least one signal and feature processing model, based on the endogenous data and the exogenous data, a set of features, determining, by a trained meta-learner having been trained on historical time series data, based on the endogenous time series data and the set of features, a respective weight for each respective forecast signal, the respective weight being indicative of a relative importance of the respective theme of the respective forecasting model, and generating, using the set of weights and the set of forecast signals, a meta-prediction.

In one or more implementations of the method, the exogenous data comprises exogenous time series-data and exogenous alternative data representative of the environment of the time series.

In one or more implementations of the method, said generating, by the at least one signal and feature processing model, based on the endogenous data and the exogenous data, the set of features comprises at least one of: generating a first subset of features potentially indicative of regime changes in the endogenous time series data, generating a second subset of features by performing a latent space representation transformation of the endogenous time series data, and generating a third subset of features by performing a transformation based on the endogenous data and the exogenous data.

In one or more implementations of the method, said generating, by the at least one signal and feature processing model, based on the endogenous data and the exogenous data, the third subset of set of features comprises: determining at least one of correlations, co-integrations and further conditional correlations between the endogenous time series data and the exogenous time series data.

In accordance with a broad aspect of the present technology, there is provided a method for performing a meta-prediction of time series by using a set of forecasting models, each forecasting model being associated with a respective forecasting theme. The method is executed by at least one processor operatively connected to at least one non-transitory storage medium, the at least one processor having access to the set of forecasting models. The method comprises: receiving, from the at least one non-transitory storage medium, time series data, generating, by using the set of forecasting models, based on the time series data, a set of forecast signals, each respective forecast signal of the set of forecast signals predicting at least one future value in the time series according to the respective forecasting theme, generating, by at least one signal and feature processing model, based on the time series data, a set of features, determining, by a trained meta-learner having been trained on historical time series data, based on the time series data and the set of features, a set of weights, the set of weights comprising a respective weight for each respective forecast signal of the set of forecast signals, the respective weight being indicative of a relative importance of the respective theme of the respective forecasting model, generating, using the set of weights and the set of forecast signals, a meta-prediction, and outputting, to a client device, at least one of an interpretation and an explanation of the meta-prediction based on the set of weights and an indication the respective themes of the set of forecasting engines.

In one or more implementations of the method, the method further comprises, generating the at least one of the interpretation and the explanation of the meta-prediction by performing at least one of: generating an interpretation signal based on the forecast signals relative to a reference forecast, expressing the set of forecast signals relative to a respective reference value, and determining a distribution of possible outcomes associated with respective probabilities based on historical forecast signals.

In one or more implementations of the method, the method further comprises: receiving historical forecast signals associated with respective historical features and respective historical weight vectors, clustering the historical weight vectors to obtain historical weight clusters, clustering the historical features to obtain historical feature clusters, associating at least one historical weight cluster with at least one historical feature cluster to obtain an associated historical weight-feature cluster, historical weights in the historical weight-feature cluster being indicative of a relative importance of the historical forecast signals, and generating, based: on the associated historical weight-feature cluster, the set of forecast signals and the set of weights, a further explanation of the meta-prediction.

In one or more implementations of the method, the method further comprises generating, based on the set of forecast signals and historical forecast signals, a set of conviction scores associated with at least one of the meta-prediction and the set of forecast signals, each respective conviction score being indicative of a respective likelihood of a forecast signal being realized, and outputting, to the client device, based on the set of conviction scores, an indication of a level of trust in the meta-prediction.

In one or more implementations, the set of forecast signals may be for the meta-prediction or any one of the forecast signals of the underlying forecasting engines.

In one or more implementations of the method, the method further comprises: generating, using a large language model (LLM), an explanation of the meta-prediction based on the weight vector, the set of features, and the respective themes of the set of forecasting models.

In accordance with a broad aspect of the present technology, there is provided a system for performing a meta-prediction of time series by using a set of forecasting models, each forecasting model being associated with a respective forecasting theme. The system comprises: at least one non-transitory storage medium storing computer-readable instructions thereon, and at least one processor operatively connected to at least one non-transitory storage medium, the at least one processor having access to the set of forecasting models. The at least one processor, upon executing the computer-readable instructions, is configured for: receiving, from the at least one non-transitory storage medium, time series data, generating, by using the set of forecasting models, based on the time series data, a set of forecast signals, each respective forecast signal of the set of forecast signals predicting at least one future value in the time series according to the respective forecasting theme, generating, by at least one signal and feature processing model, based on the time series data, a set of features, determining, by a trained meta-learner having been trained on historical time series data, based on the time series data and the set of features, a set of weights, the set of weights comprising a respective weight for each respective forecast signal of the set of forecast signals, the respective weight being indicative of a relative importance of the respective theme of the respective forecasting model, and generating, using the set of weights and the set of forecast signals, a meta-prediction.

In one or more implementations of the system, said generating, by at least one signal and feature processing model, based on the time series data, the set of features comprises: applying a latent space transformation on the time series data to obtain at least a subset of the set of features.

In one or more implementations of the system, said applying the latent space transformation on the time series data to obtain at least the subset of the set of features comprises generating a synthetic time series based on the time series data and extracting at least the subset of features therefrom.

In one or more implementations of the system, the time series data comprises a set of time series, and said generating, by the at least one signal and feature processing model, based on the time series data, the set of features comprises: determining interactions between a first time series and a second time series of the set of time series to obtain a further subset of features.

In accordance with a broad aspect of the present technology, there is provided a system for performing a meta-prediction of time series by using a set of forecasting models, each forecasting model being associated with a respective forecasting theme. The system comprises: at least one non-transitory storage medium storing computer-readable instructions thereon, and at least one processor operatively connected to at least one non-transitory storage medium, the at least one processor having access to the set of forecasting models. The at least one processor, upon executing the computer-readable instructions, is configured for: receiving, from the at least one non-transitory storage medium, endogenous data comprising endogenous time series data associated with endogenous metadata, receiving, from the at least one non-transitory storage medium, exogenous data characterizing an environment of the time series, generating, by using the set of forecasting models, based on the endogenous and exogenous data, a set of forecast signals, each respective forecast signal of the set of forecast signals predicting at least one future value in the time series according to the respective forecasting theme, generating, by at least one signal and feature processing model, based on the endogenous data and the exogenous data, a set of features, determining, by a trained meta-learner having been trained on historical time series data, based on the endogenous time series data and the set of features, a respective weight for each respective forecast signal, the respective weight being indicative of a relative importance of the respective theme of the respective forecasting model, and generating, using the set of weights and the set of forecast signals, a meta-prediction.

In one or more implementations of the system, the exogenous data comprises exogenous time series-data and exogenous alternative data representative of the environment of the time series.

In one or more implementations of the system, said generating, by the at least one signal and feature processing model, based on the endogenous data and the exogenous data, the set of features comprises at least one of: generating a first subset of features potentially indicative of regime changes in the endogenous time series data, generating a second subset of features by performing a latent space representation transformation of the endogenous time series data, and generating a third subset of features by performing a transformation based on the endogenous data and the exogenous data.

In one or more implementations of the system, said generating, by the at least one signal and feature processing model, based on the endogenous data and the exogenous data, the set of features comprises: determining at least one of correlations, co-integrations and further conditional correlations between the endogenous time series data and the exogenous time series data.

In accordance with a broad aspect of the present technology, there is provided a system for performing a meta-prediction of time series by using a set of forecasting models, each forecasting model being associated with a respective forecasting theme. The system comprises: at least one non-transitory storage medium storing computer-readable instructions thereon, and at least one processor operatively connected to at least one non-transitory storage medium, the at least one processor having access to the set of forecasting models. The at least one processor, upon executing the computer-readable instructions, is configured for: receiving, from the at least one non-transitory storage medium, time series data, generating, by using the set of forecasting models, based on the time series data, a set of forecast signals, each respective forecast signal of the set of forecast signals predicting at least one future value in the time series according to the respective forecasting theme, generating, by at least one signal and feature processing model, based on the time series data, a set of features, determining, by a trained meta-learner having been trained on historical time series data, based on the time series data and the set of features, a set of weights, the set of weights comprising a respective weight for each respective forecast signal of the set of forecast signals, the respective weight being indicative of a relative importance of the respective theme of the respective forecasting model, generating, using the set of weights and the set of forecast signals, a meta-prediction, and outputting, to a client device, at least one of an interpretation and an explanation of the meta-prediction based on the set of weights and an indication the respective themes of the set of forecasting engines.

In one or more implementations of the system, the at least one processor is further configured for, generating the at least one of the interpretation and the explanation of the meta-prediction by performing at least one of: generating an interpretation signal based on the forecast signals relative to a reference forecast, expressing the set of forecast signals relative to a respective reference value, and determining a distribution of possible outcomes associated with respective probabilities based on historical forecast.

In one or more implementations of the system, the at least one processor is further configured for: receiving historical forecast signals associated with respective historical features and respective historical weight vectors, clustering the historical weight vectors to obtain historical weight clusters, clustering the historical meta-learner features to obtain historical feature clusters, associating at least one historical weight cluster with at least one historical feature cluster to obtain an associated historical weight-feature cluster, historical weights in the historical weight-feature cluster being indicative of a relative importance of the historical forecast signals, and generating, based on the associated historical weight-feature cluster, the set of forecast signals and the set of weights, a further explanation of the meta-prediction.

In one or more implementations of the system, the at least one processor is further configured for: generating, based on the set of forecast signals and historical forecast signals, a set of conviction scores associated with at least one of the meta-prediction and the set of forecast signals, each respective conviction score being indicative of a respective likelihood of a forecast signal being realized, and outputting, to the client device, based on the set of conviction scores, an indication of a level of trust in the meta-prediction.

In one or more implementations of the system, the at least one processor is further configured for: generating, using a large language model (LLM), an explanation of the meta-prediction based on the weight vector, the set of features, and the respective themes of the set of forecasting models.

The aforementioned implementations of methods, systems and non-transitory storage mediums may be modified and combined.

### Terms and Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “computing device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drives, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), optical, infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a computing device in accordance with one or more non-limiting implementations of the present technology.

FIG. 2 depicts a schematic diagram of a communication system in accordance with one or more non-limiting implementations of the present technology.

FIG. 3 depicts a schematic diagram of a meta-prediction procedure in accordance with one or more non-limiting implementations of the present technology.

FIG. 4 depicts a schematic diagram of an explanation and interpretation procedure in accordance with one or more non-limiting implementations of the present technology.

FIG. 5 depicts a schematic diagram of a clustering procedure in accordance with one or more non-limiting implementations of the present technology.

FIG. 6 depicts a schematic diagram of a conviction scoring procedure in accordance with one or more non-limiting implementations of the present technology.

FIG. 7 depicts a schematic diagram of a meta-prediction selection procedure in accordance with one or more non-limiting implementations of the present technology.

FIG. 8 depicts a flow chart of a first method for generating meta-predictions using dynamically selected forecast signals in accordance with one or more non-limiting implementations of the present technology.

FIG. 9 depicts a flow chart of a second method for generating meta-predictions using dynamically selected forecast signals in accordance with one or more non-limiting implementations of the present technology.

FIG. 10 depicts a flow chart of a third method for generating meta-predictions using dynamically selected forecast signals in accordance with one or more non-limiting implementations of the present technology.

FIG. 11 depicts the feature engineering block in parallel with unsupervised learning to identify regimes resulting from the unsupervised learning model.

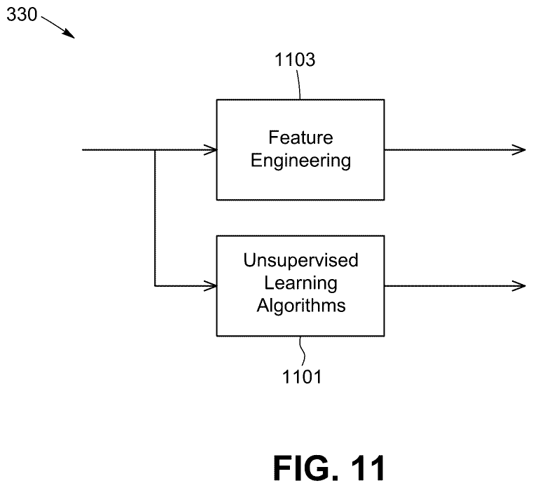

FIG. 12 illustrates regimes in a time series identified by the unsupervised learning model.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting implementations of the present technology, the processor may be a processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computing Device

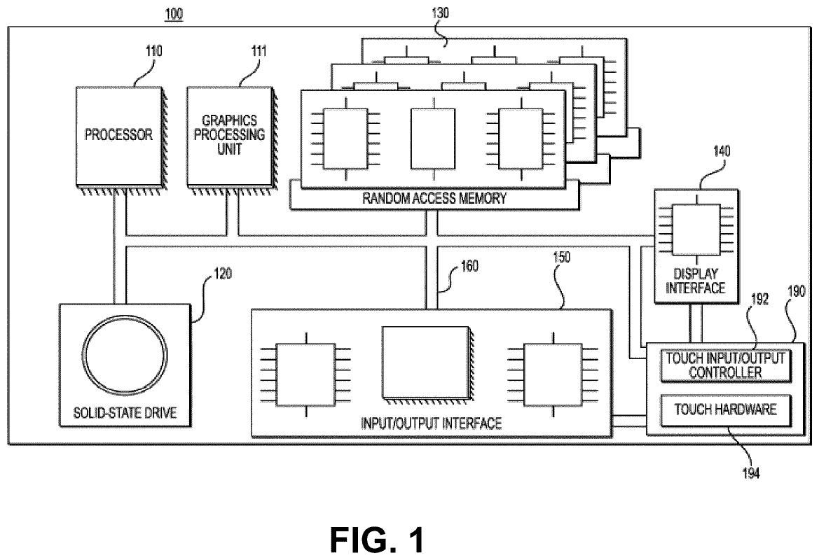

Referring to FIG. 1, there is shown a computing device 100 suitable for use with some implementations of the present technology, the computing device 100 comprising various hardware components including one or more single or multi-core processors collectively represented by processor 110, a graphics processing unit (GPU) 111, a solid-state drive 120, a random access memory 130, a display interface 140, and an input/output interface 150.

Communication between the various components of the computing device 100 may be enabled by one or more internal and/or external buses 160 and/or physical interconnections (e.g., Land Grid Array (LGA), Pin Grid Array (PGA), a PCI express bus, SATA, NVMe, USB, etc.) to which the various hardware components are electronically coupled.

The input/output interface 150 may be coupled to a touchscreen 190 and/or to the one or more internal and/or external buses 160. The touchscreen 190 may be part of the display. In one or more implementations, the touchscreen 190 is the display. The touchscreen 190 may equally be referred to as a screen 190. In the implementations illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more implementations, the input/output interface 150 may be connected to a keyboard (not shown), a mouse (not shown) or a trackpad (not shown) allowing the user to interact with the computing device 100 in addition or in replacement of the touchscreen 190. In one or more other implementations, the input/output interface 150 may enable a user to interact by using voice.

According to implementations of the present technology, the solid-state drive 120 stores program instructions suitable for being loaded into the random-access memory 130 and executed by the processor 110 and/or the GPU 111 for performing meta-predictions for values of at least one time series using dynamically selected forecasts generated by a set of forecasting models. For example, the program instructions may be part of a library or an application.

The computing device 100 may be implemented as a server, a desktop computer, a laptop computer, a tablet, a smartphone, a personal digital assistant or any device that may be configured to implement the present technology, as it may be understood by a person skilled in the art.

Furthermore, aspects of the present technology may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SoC) where each or many of the components illustrated in FIG. 1 may be integrated onto a single integrated circuit. Such a SoC device may include one or more processing units, graphics units, communications units, system virtualization units, and various application functionality all of which are integrated (or “burned”) onto the chip substrate as a single integrated circuit. Aspects of the present technology may also be practiced using other technologies capable of performing logical operations such as, for example, AND, OR, and NOT, including but not limited to mechanical, optical, fluidic, and quantum technologies.

### Communication System

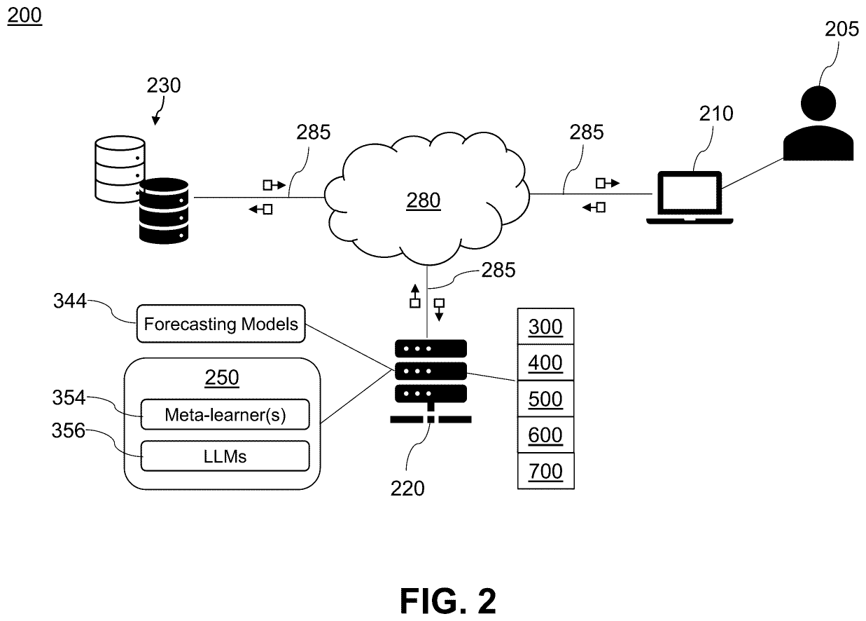

Referring to FIG. 2, there is shown a schematic diagram of a communication system 200, the communication system 200 being suitable for implementing one or more non-limiting implementations of the present technology. It is to be expressly understood that the communication system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the communication system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the communication system 200 may provide in certain instances simple implementations of the present technology, and that where such is the case they have been presented in this manner as an aid to understanding. As persons skilled in the art would understand, various implementations of the present technology may be of a greater complexity.

The communication system 200 comprises inter alia a client device 210 associated with a user 205, a server 220, and one or more databases 230 communicatively coupled over a communications network 280 via respective communication links 285.

### Client Device

The communication system 200 comprises a client device 210. The client device 210 is associated with the user 205. As such, the client device 210 can sometimes be referred to as a “electronic device”, “end user device” or “client electronic device”. It should be noted that the fact that the client device 210 is associated with the user 205 does not need to suggest or imply any mode of operation-such as a need to log in, a need to be registered, or the like.

The client device 210 comprises one or more components of the computing device 100 such as one or more single or multi-core processors collectively represented by processor 110, the graphics processing unit (GPU) 111, the solid-state drive 120, the random access memory 130, the display interface 140, and the input/output interface 150.

It will be appreciated that the client device 210 may be implemented as a server, a desktop computer, a laptop, a smartphone and the like.

In one or more implementations, the client device 210 is configured to execute a browser application (not shown). The purpose of the given browser application is to enable the user 205 to access one or more web resources. How the given browser application is implemented is not particularly limited. Non-limiting examples of the given browser application that is executable by the client device 210 include GOOGLE Chrome™, MOZILLA Firefox™, MICROSOFT Edge™, and APPLE Safari™.

### Server

The server 220 is configured to inter alia: (i) access a set of forecasting models 344; (ii) access a set of machine learning (ML) models 250; (iii) execute a meta-prediction procedure 300; (iv) execute an interpretation and explanation procedure 400; (v) optionally execute a clustering procedure 500; (vi) optionally execute a conviction scoring procedure 600; and (vii) optionally execute a meta-prediction selection procedure 700.

How the server 220 is configured to do so will be explained in more detail herein below.

It will be appreciated that the server 220 can be implemented as a conventional computer server and may comprise at least some of the features of the computing device 100 shown in FIG. 1. In a non-limiting example of one or more implementations of the present technology, the server 220 is implemented as a server running an operating system (OS). Needless to say that the server 220 may be implemented in any suitable hardware and/or software and/or firmware or a combination thereof. In the disclosed non-limiting implementation of the present technology, the server 220 is a single server. In one or more alternative non-limiting implementations of the present technology, the functionality of the server 220 may be distributed and may be implemented via multiple servers (not shown).

The implementation of the server 220 is well known to the person skilled in the art. However, the server 220 comprises a communication interface (not shown) configured to communicate with various entities (such as the database 230, for example and other devices potentially coupled to the communication network 280) via the communication network 280. The server 220 further comprises at least one computer processor (e.g., the processor 110 of the computing device 100) operationally connected with the communication interface and structured and configured to execute various processes to be described herein.

### Machine Learning (ML) models

The server 220 has access to a set of ML models 250.

In one or more implementations, the set of ML models 250 comprises inter alia a set of classification ML models (not shown). Additionally, or alternatively, the set of ML models 250 comprises a set of regression ML models (not shown).

It will be appreciated that depending on the type of prediction task to be performed, i.e., classification or regression, the set of ML models may comprise only the set of classification ML model or only the set of regression ML model or a combination thereof.

The set of classification ML models comprises one or more classification ML models, also known as classifiers, which outputs models that attempt to estimate the mapping function (f) from the input variables (x) to one or more discrete or categorical output variables (y). The set of classification ML models may include linear and/or non-linear classification ML models.

Non-limiting examples of classification ML models include: Perceptrons, Naive Bayes, Decision Tree, Logistic Regression, K-Nearest Neighbors, Artificial Neural Networks (ANNs)/Deep Learning (DL), Support Vector Machines (SVM), and ensemble methods such as Random Forest, Bagging, AdaBoost, XGBoost and the like.

The set of regression ML comprises one or more regression ML models which output models that attempt to estimate the mapping function (f) from the input variables (x) to numerical or continuous output variables (y).

Non-limiting examples of regression ML models include: Linear Regression, Ordinary Least Squares Regression (OLSR), Stepwise Regression, Multivariate Adaptive Regression Splines (MARS), Locally Estimated Scatterplot Smoothing (LOESS), Logistic Regression, and classification models adapted to produce regression outputs. In the context of time-series forecasting, regression models may also include classical time series forecasting methods such as Auto-Regressive Moving Average (ARMA), Auto-regressive Integrated Moving Average (ARIMA), exponential smoothing methods, Generalized Auto-Regressive Heteroscedasticity (GARCH) and many others.

In one or more implementations, the set of ML models 250 comprises at least a portion of the set of forecasting models 344, one or more meta-learners 354 and large language models (LLMs) 356.

In one or more implementations, the set of ML models 250 comprises large language models (LLMs) 356 configured to perform text prediction, text classification and the like. Non-limiting examples of LLMs includes OpenAI's GPT series (e.g., GPT-3, GPT-4), Google's BERT and Transformer models, Microsoft's Turing-NLG, Meta's BART and Llama, and XLNet, among others.

In one or more implementations, the set of ML models 250 may have been previously initialized, and the server 220 may obtain the set of ML models 250 from the database 230, or from a computing device connected to the communication network 280.

In one or more other implementations, the server 220 obtains the set of ML models 250 by performing a model initialization procedure to initialize the model parameters and model hyperparameters of the set of ML models 250.

The model parameters are configuration variables of a machine learning model and which are estimated or learned from training data, i.e. the coefficients are chosen during learning based on an optimization strategy for outputting a prediction according to a prediction task.

In one or more implementations, the server 220 obtains the hyperparameters in addition to the model parameters for the set of ML models 250. The hyperparameters are configuration variables which determine the structure of a given ML model and how the given ML model is trained.

It will be appreciated that the number of model parameters to initialize will depend on inter alia the type of model and prediction (i.e., classification or regression model), the architecture of the model (e.g., DNN, SVM, ensemble trees, etc.), and the model hyperparameters (e.g., learning rates, number of layers, type of layers, number of neurons in a NN).

In one or more implementations, the hyperparameters include one or more of: number of trees, number of hidden layers and units, an optimization algorithm, a learning rate, momentum, an activation function, a minibatch size, a number of epochs, dropout, etc., the type of parameter depending upon the type of model.

In one or more implementations, training of the set of ML models 250 is repeated until a termination condition is reached or satisfied. As a non-limiting example, the training may stop upon reaching one or more of: a desired accuracy, a computing budget, a maximum training duration, a lack of improvement in performance, a system failure, and the like.

In one or more implementations, the server 220 may execute one or more of the set of ML models 250. In one or more alternative implementations, one or more of the set of ML models 250 may be executed by another server (not depicted), and the server 220 may access the one or more of the set of ML models 250 for training or for use by connecting to the server (not shown) via an API (not depicted), and specify parameters of the one or more of the set of ML models 250, transmit data to and/or receive data from the ML models 250, without directly executing the one or more of the set of ML models 250.

As a non-limiting example, one or more ML models of the set of ML models 250 may be hosted on a cloud service providing a machine learning API.

### Database

The communication system 200 comprises one or more databases 230, which are referred to as database 230 hereinafter.

A database 230 is communicatively coupled to the server 220 and the client device 210 via the communications network 280 but, in one or more alternative implementations, the database 230 may be directly coupled to the server 220 without departing from the teachings of the present technology. Although the database 230 is illustrated schematically herein as a single entity, it will be appreciated that the database 230 may be configured in a distributed manner, for example, the database 230 may have different components, each component being configured for a particular kind of retrieval therefrom or storage therein.

The database 230 may be a structured collection of data, irrespective of its particular structure or the computer hardware on which data is stored, implemented or otherwise rendered available for use. The database 230 may reside on the same hardware as a process that stores or makes use of the information stored in the database 230 or it may reside on separate hardware, such as on the server 220. The database 230 may receive data from the server 220 for storage thereof and may provide stored data to the server 220 for use thereof.

In one or more implementations, the database stores one or more labelled training datasets (not shown).

The labelled training dataset or set of labelled training examples comprises a plurality of training examples, where each labelled training example is associated with a respective label. The labelled training dataset may be used to train one or more of the ML models described herein. It will be appreciated that the nature of the labelled training dataset and the number of training data is not limited and depends on the task at hand.

In one or more implementations, the database 230 may store ML file formats, such as .tfrecords, .csv, .npy, and .petastorm as well as the file formats used to store models, such as .pb and .pkl. The database 230 may also store well-known file formats such as, but not limited to image file formats (e.g., .png, .jpeg), video file formats (e.g., .mp4, .mkv, etc), archive file formats (e.g., .zip, .gz, .tar, .bzip2), document file formats (e.g., .docx, .pdf, .txt) or web file formats (e.g., .html). The database 230 may also store data that has been structured as a time-series format. The database 230 may be structured using an implementation of the SQL standard and data may be stored directly in SQL tables natively, including time-series data.

In one or more implementations of the present technology, the database 230 is configured to store one or more of: (i) an indication of a set of assets; (ii) endogenous time series data associated with at least one asset, including endogenous metadata; (iii) exogenous data associated with the at least one asset, including exogenous time series data and alternative exogenous data; (iv) parameters of the set of ML models 250 and set of forecasting models 344; (v) features; and (vi) weights, forecast signals, meta-predictions and associated interpretations and explanations.

### Communication Network

In one or more implementations of the present technology, the communications network 280 is the Internet. In one or more alternative non-limiting implementations, the communication network 280 may be implemented as any suitable local area network (LAN), wide area network (WAN), a private communication network or the like. It will be appreciated that implementations for the communication network 280 are for illustration purposes only. How a communication link 285 (not separately numbered) between the client device 210, the server 220, the database 230, and/or another electronic device (not shown) and the communications network 280 is implemented will depend inter alia on how each electronic device is implemented.

It will be appreciated that the communication system 200 may be implemented as a cloud computing system, a local computing system or its functionality may be provided by a single computing device including less components or more components, without departing from the scope of the present technology.

### Meta-Prediction Procedure

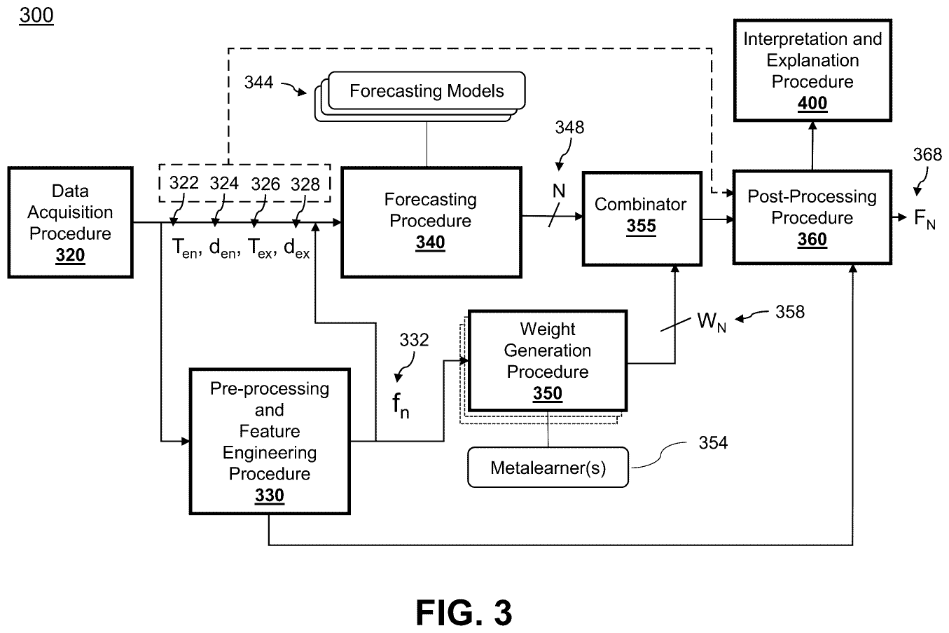

With reference to FIG. 3, there is shown a schematic diagram of a meta-prediction procedure 300 in accordance with one or more non-limiting implementations of the present technology.

In one or more implementations of the present technology, the server 220 executes the meta-prediction procedure 300. In alternative implementations, the server 220 may execute at least a portion of the meta-prediction procedure 300, and one or more other servers (not shown) may execute other portions of the meta-prediction procedure 300.

In one or more implementations, the meta-prediction procedure 300 may be executed upon receiving a request from a computing device, such as the client device 210 associated with the user 205. The request may be provided, as a non-limiting example, via a web platform accessible by the client device 210. In one or more other implementations, the meta-prediction procedure 300 may be executed synchronously, asynchronously and without receiving a request (e.g., at predetermined time periods).

In one or more implementations, the meta-prediction procedure 300 comprises at least a data acquisition procedure 320, a feature engineering procedure 330, a forecasting procedure 340, a weight generation procedure 350, and a combinator 355. In some implementations, the meta-prediction procedure 300 further includes a post-processing procedure 360.

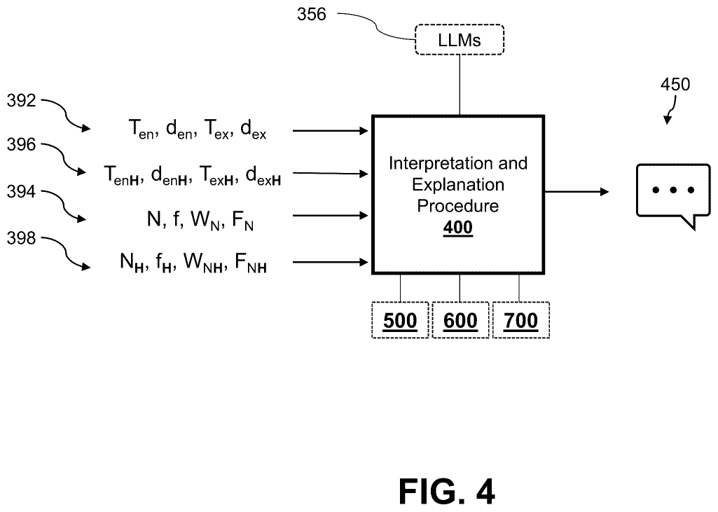

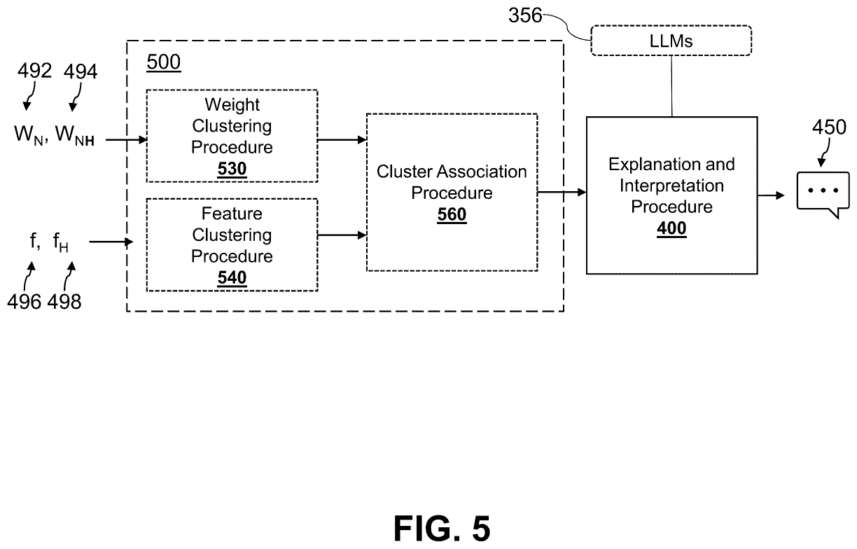

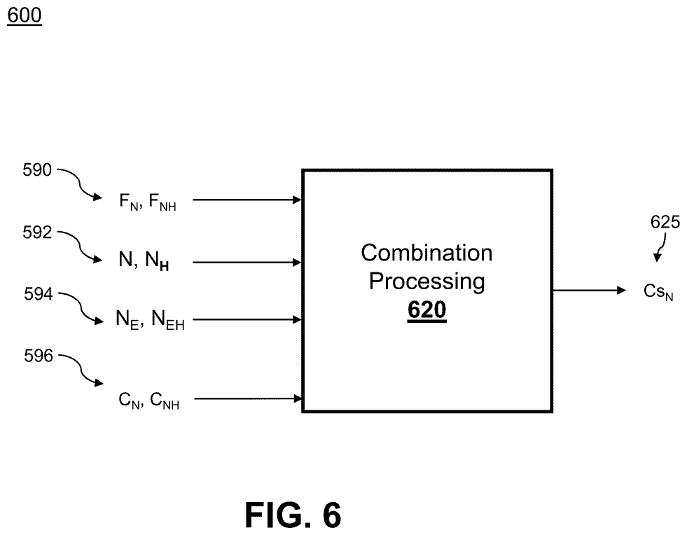

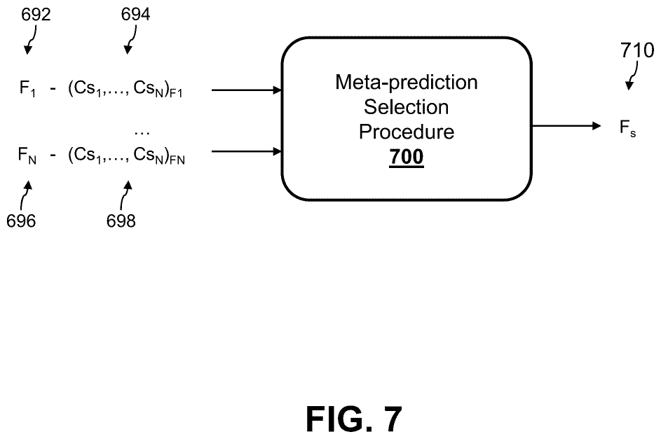

In some implementations, the post-processing procedure 360 comprises one or more of: an interpretation and explanation procedure 400 (FIG. 4), a conviction scoring procedure 600 (FIG. 6), a clustering procedure 500 (FIG. 5), and a meta-prediction selection procedure 700 (FIG. 7). A person skilled in the art will appreciate that the procedures 400, 500, 600 and 700 do not need to all be included in the post-processing procedure 360. A combination of one or more of the procedures 400, 500, 600, 700 will meet objectives of the present description. In this sense, post-processing procedure 360 is modular, in that different blocks included therein can be used and leveraged according to the needs of the user.

Broadly speaking, the meta-prediction procedure 300 is configured to retrieve or receive time series data associated with a given asset and perform a meta-prediction based on at least the time series data. The meta-prediction is a weighted combination of forecast signals generated by a set of forecasting models 344, where each forecasting model generates a respective forecast signal according to a theme, and where the weights, which represent the relative importance of the forecast signal, are determined by one or more meta-learners 354 having been trained therefor.

In some implementations, the meta-prediction and forecast signals are associated with forecasting attribution signals and explanatory signals which provide interpretation and explanations of the weights and relative importance of one or more forecast signals in the meta-prediction.

### Data Acquisition Procedure

The data acquisition procedure 320 is configured to receive inter alia: (i) an indication of a set of assets comprising at least one given asset; (ii) for each of the set of assets, endogenous data comprising at least one of endogenous time series data 322 and metadata 324; and (iii) for each of the set of assets, exogenous data comprising at least one of exogenous time series data 326 and exogenous alternative data 328.

The reader will appreciate that the endogenous time series data 322 can include historical endogenous data comprising historical time series data and associated endogenous metadata; and that the at least one exogenous time series data can include historical exogenous data including historical exogenous time series data and historical exogenous alternative data.

In one or more implementations, the data acquisition procedure 320 is further configured to receive, for each of the set of assets: (i) previously forecast signals associated with each of the set of historical assets; (ii) previously calculated weights used by meta-learners; (iii) previously calculated meta-predictions performed using the historical forecast signals and previously calculated weights; and (iv) previously identified features used for generating the historical weights.

The reader will appreciate that since time series vary in time, it is possible for the system to provide a prediction at a moment in time, say t0. Some time later, say at time t1, the values of the time series will have changed between t0 and t1. In some cases, it may be useful to ingest not only the time series for each of the set of assets, but also the previously calculated values for the forecast signals, calculated weights and features, as this will inform the meta-learner.

The previously forecast signals, previously calculated weights, previously identified features and previously calculated meta-predictions may have been stored upon executing implementations of the meta-prediction procedure 300, or at any previous point in time during the training phase.

In one or more implementations, the data acquisition procedure 320 is configured to receive the data from one or more storage mediums, such as computer memories, databases (e.g., database 230) or other types of devices (e.g. sensors) which is connected to the computing device executing the data acquisition procedure 320.

In some implementations, current endogenous data, current exogenous data, current endogenous data, current exogenous data may be provided from different data sources.

### Asset

As used herein, an asset refers to any item, factor, or variable that can be measured and quantified over a period of time. A given asset represents an entity interacting in an environment, where the given asset is associated with characteristics.

The characteristics associated with the entity include at least one time series data. It will be appreciated that there may be a need to forecast such time series because they vary over time and thus forecasting future values of the time series may be useful in different contexts.

An asset may also include meta-data, some of which may or may not be expressed as time series data. For example, in the financial industry, an asset can be a share of a company, traded on a stock exchange platform. The meta-data associated with the share (or listing) can include the fact that the asset is a stock or a bond, that the company associated with the asset is a small cap or large cap. Meta-data can further include a sector of activity. The reader will appreciate that any asset, whatever it may be, can be associated with meta-data.

An asset may be affected by its environment, including by other assets. It may also interact with other assets, i.e., one or more assets may affect said asset, and vice-versa. In a social systems context, this is known as reflexivity, but it can also apply to any other systems, in the physical world or other types of representations.

Given the above characteristics, a group of assets can also be considered as an ecosystem, as not only are individual assets interacting with their environment, but a group of assets, as a distinct entity, can also as a group interact with their environment.

The given asset (i.e., entity) is associated with endogenous time series data for which a forecast or prediction is performed. The endogenous time series data is associated with characteristics in the form of endogenous metadata, which describe or characterize the time series data of the given asset. In the context of the present technology, a “time series” refers to a sequence of data points in temporal chronological order.

### Endogenous data

Endogenous data is any type of data that is derived from the resource or the underlying asset associated thereto. In the context of the present technology, endogenous data comprises time series data and associated metadata.

Referring again to the financial industry, the asset can be any tradable instrument. Thus, endogenous data includes times series such as the price or trading volume, and the instrument may be an option, a futures contract, an ETF, an ETN, a mutual fund, a stock, a currency pair, etc. In this non-limiting example, endogenous data may include data produced by any security that is tradable, and which can be expressed in the form of a time series. Endogenous data may also include non-time series information in the form of metadata that describes the given asset. As a non-limiting example, endogenous metadata may include characteristics of a stock, a bond, the market where it trades (US, Europe, etc.) and the like.

As another non-limiting example, time series data may include sensor data, transaction data, financial transactions, customer transactions, order history, operational analytics, application data, fleet data, logistics metrics data, tick data, fintech data, trading data, event data, vector data, weather data, insurance data, and call records. In other words, the time series data may include any type of data for which a prediction or forecasting can be made.

### Structural Breaks/Regimes

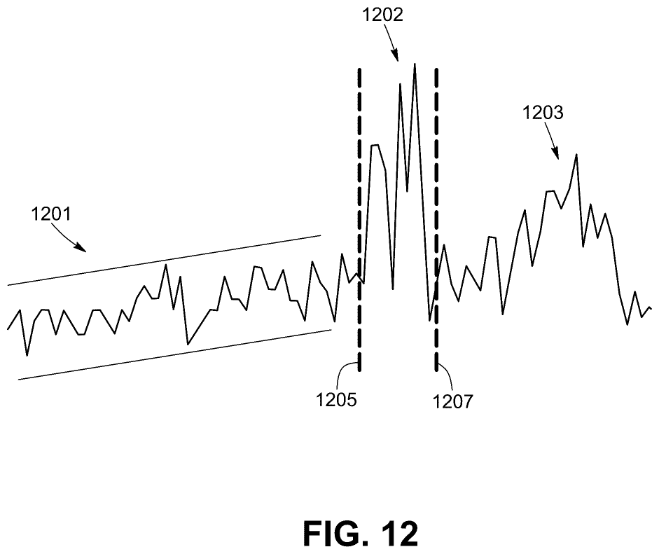

A given time series may include one or more structural breaks 1205, 1207, as shown in FIG. 12.

Structural breaks in time series data refer to abrupt and/or substantial alterations in the time series data's underlying characteristics over time. The one or more structural breaks may include level shifts, variance shifts, regime changes, and parameter instability.

Level shifts are generally characterized by sudden and sustained changes in the data's mean or central tendency; variance shifts are generally characterized by alterations in data variability, such as heteroscedasticity in the data; regime changes are characterized by shifts from one stable state or regime to another, resulting in differences in statistical properties over time, such as non-stationarity, or the underlying generating process driving the behavior of the time-series; and parameter instability, which are generally characterized by sudden changes in the coefficients of statistical models used to describe the time series, affecting their predictive accuracy and reliability. The underlying generating process driving the behavior of the time-series may be affected by many types of exogenous phenomena, which could result in dynamically changing statistical properties in the time-series over time. These exogenous phenomena may take many forms, and the nature of the relationship between said phenomena and the time-series may also change over time. The combination of all these effects and interactions, taken together as a group, can be considered a regime, while any meaningful change over time of these effects and interactions can be considered as a regime change or a structural break.

One or more implementations of the present technology aim to detect and use structural breaks including regime changes in time series to perform predictions, as explained hereinafter.

In one or more implementations, regimes in time series data are identified by leveraging unsupervised machine learning techniques 1101 and combining these regimes with additional signals to improve the accuracy of the results. Each regime has specific characteristics that can be exploited, and combining regimes with additional signals, such as a binary or ternary signal indicating the direction of the trend can be useful to further provide context to the eventual meta-prediction signal FN.

Once regimes are discovered, the next step is to extract statistics of the time series behavior for each regime. This involves analyzing the specific characteristics and behaviors of the time series within each regime.

The discovered regimes can be combined with additional signals, such as a binary signal indicating the direction of a trend in a given regime. This combination aims to improve the likelihood of achieving desired results by creating sub-regimes based on the direction of a trend.

In some embodiments, several independent models or several different instances of unsupervised models are used. In one example, a non supervised stand alone (NSSA) model is used to produce regimes. Another is the metalearner which itself includes its own unsupervised model but being a different instance of the NSSA. For example, in some cases, it may be desirable to perform data transformations to predict the difference between an index and the stock under study, as the objective of the model could be to outperform the index. Alternatively, one may desire to predict a value other than prices or prices relative to the index, such as earnings, predicted earnings, the difference between the asset's earning and those of a sector.

Referring now for FIG. 12, an unsupervised machine-learning model such as NSSA can identify regimes 1201, 1202, 1203. Regime 1201 can be characterized as a stable regime. Regime 1202 can be characterized as a volatile regime, while regime 1203 can be characterized as a recuperation regime, different from the stable regime 1201. In an example, regime 1201 is bounded by a narrow range boundary, with low volatility. Regime 1202 exhibits values that are outside of the range boundary of regime 1201, as well as very high volatility. While regime 1203 exhibits large volatility, the ranges are between those of regime 1201 and regime 1202. The NSSA itself may advantageously leverage more than one type of unsupervised algorithm by combining different methods of discovering structures in data. A person skilled in the art will recognize that unsupervised machine learning models are well known, and that selecting one is within the skill of this person, based on the needs of a particular application. In addition, one or more models can be used alone or in combination, whether stacked or running in parallel. A set of regimes identified by this process is shown in FIG. 12, where the regimes are graphically illustrated.

In a preferred embodiment, discovering regimes in a data series can be used to predict, based on the time series, a probability of the time series being currently in any of the discovered regimes and associate said probabilities to time series performance. For example, in the financial industry, illustrating the probability of being in any regime can be associated with financial metrics, in order to understand the association between probabilities and financial performance of the stock. Performing the prediction for i.e. a universe of stocks such as the S&P500, individual stocks can be ranked in order to discover the stocks that are in the most attractive regime at the time of the analysis, to then identify the stocks that may outperform an index. The scoring and ranking by regime attractiveness can be characterized as a Regime Score (RS). In a preferred embodiment of the RS, regimes are associated with one or many financial metrics or other characteristics related to the time series, including, but not limited to, observed behaviors such as stability, predictability, volatility or the expected survival time of any relevant characteristics of the time series. In this way, the RS can be used to measure quality, desirability, relative attractiveness or any other relevant performance measure of each regime for each asset. In one embodiment, the RS can be used to rank the assets to offer a way to recommend the most attractive assets at a given time. In another embodiment, the RS can be used to build a recommender system using machine learning and/or artificial intelligence algorithms to deliver recommendations. In yet another embodiment, the RS can be combined with one or many other scoring methods to offer a composite score and optionally, to form a basis for a more complete recommender system. In further embodiments, the RS can be used as a basis to build visual aids, including graphs, charts, tables and statistics that can be readily interpreted by a user because it is constructed using metrics that have specific meanings to such user. An option to query the recommender system could be added using an appropriately trained large language model (LLM). One skilled in the art will readily recognize these as examples of possible RS embodiments, interpretation methods and recommender systems, and that many other embodiments can be developed in practice.

Separately, a metamodel built on prices relative to the given universe, in this case the S&P500 is built, (i.e. calculating the difference between the change in the stock price and the S&P500), in order to predict which stock or stocks have the highest likelihood of being in a specific regime in a given universe, in this case the S&P500. Ranking the individual stock using the Conviction Score (CS), the stocks with the highest likelihood of beating the S&P500 index in the coming weeks are visually apparent.

Finally, the RS with the CS are combined visually with graphs, and by constructing one or more composite scores. These composite scores become highly relevant as they can show the intersection of stocks that are in an excellent high-performance (HR) regime and that have the highest probability of beating the S&P500 (CS) index.

One will appreciate that more traditional scores can be calculated, for example with fundamental financial ratios such as, for example, price-to-earnings ratio, growth rate, etc., or with classic technical indicators such as a Relative Strength Index (RSI). A composite score that includes the RS, the CS and any other financial ratio (or their rankings against the universe), to rank each stock as a percentile against its peers in the universe can be calculated, allowing a user to apply various metrics to inform subsequent decision-making on whether to buy, hold, sell, or short any particular stock. While the above example has been provided in the field of investment management, the notions can be applied to any asset that can be compared to another, exogenous time series.

While unsupervised models are well known in the art, including such as a model to calculate a composite score provides additional explainability and context to the predictions calculated by the system.

Further advantageously, the concept of sub regimes can be applied to the discovery of the regimes. In this case, each regime is partitioned based on the direction of the trend, resulting in twice as many sub regimes. Venn diagrams can be used to find the intersection of usefulness between the characteristics observed in the regimes and the behavior of the trend direction. This helps identify the most attractive subset of behaviors within a regime.

### Exogenous Data

The environment of the given asset is characterized by exogenous data, which includes independent variables that may influence the behavior of endogenous time series data of a given asset, but that may not be directly related to the given asset. It should be noted that the converse may also happen, where a given asset's endogenous data may affect its environment, following the concept of reflexivity. It will be appreciated that endogenous and exogenous data may interact in various ways and these relationships may be time-varying. varying. The exogenous data may be used to derive features to perform a forecast and/or a meta-prediction and which may be used to explain the forecast and/or meta-prediction.

The exogenous data may include exogenous time series data, i.e., time series data which may influence the endogenous time series data, but which may not be directly related to the given asset.

The exogenous data may include alternative exogenous data, which may be any form of data not in the form of time series that may influence the behavior of the given asset.

It will be appreciated that endogenous and/or exogenous time series data may be represented over various timeframes. As a non-limiting example, the time series data may comprise information relating to the attributes of a specified asset as updated at thirty second intervals and dating back ten years, or it could be daily samples dating back a year or less.

The exogenous data may be received from the database 230 or from one or more other databases (not shown). In some implementations, at least a portion of the exogenous data may be pre-processed to be in a format that can be processed by the different procedures described herein. In one or more other implementations, a portion of the exogenous data may be in an unstructured format and may be pre-processed during the data acquisition procedure 320 for use by the different procedures described herein.

Exogenous alternative data may include economic data, market data, financial ecosystem data such as liquidity of the market, banking stresses, interest rates and so on. The exogenous alternative data may include satellite pictures that show traffic patterns and can be a proxy for economic activity, geo-political indicators including election prediction data, social media data and the like. Exogenous alternative data may include a broad set of data that may provide predictive value for the asset, either directly or indirectly in combination with all other data provided as input.

The exogenous alternative data may or may not be already in a format that is directly processable. The exogenous data may include news reports, social media feeds, other textual information sources, audio files (e.g., audio books, podcasts, microblogging, and audio extracted from other file formats such as video on web-based services or sites such as, for example, YouTube™) and video files. The exogenous alternative data may also include corporate communications document, such as for example the regular securities-related or debt-related filings that corporate entities are required to file with governmental regulatory agencies.

The exogenous alternative data may include for example weather data, such as real-time (current), historical (past), and forecasted or predicted (future) field-level data representative of assessments of weather conditions, for a specific geographical area or for more broader geographical areas. It will be appreciated that such field-level data representative of assessments of weather conditions may be produced by many different sources of meteorological data to provide historical weather data, current field-level weather data, forecasted or predicted weather data (such as information provided in long-range climatological and/or meteorological forecasting from predictive weather models), and observed weather data such as data from both in-situ and remotely-sensed observation platforms. Weather information may also be combined, for example from existing weather prediction models or historical data), with data from weather radar systems and satellites to reconstruct the current or previous weather conditions on any particular area to be analyzed.

The exogenous alternative data may include image data, such as that collected by satellite systems, photography or video captured by remotely-piloted vehicles, commonly referred to as drones, or field-based robots configured to generate field-level images, such as those using in-field sensors. Manned and unmanned aerial reconnaissance craft may also be used to acquire image data for processing. Image data may be processed and utilized, for example, to discern and assess field utilization, and crop and plant growth, health, and any changes thereto over time, that later impact harvesting and production of commodities such as corn and wheat. Image data may be comprised, at least in part, of information in pixels representing different ranges of frequencies along the electromagnetic spectrum, for example where sensors configured with satellite systems include a multi-spectral instrument imaging system that captures and samples data in different spectral bands.

The exogenous data may also include other information such as data collected from sensors or other devices, whether affixed or coupled to particular objects or positioned in or near particular areas.

Historical endogenous data may include past endogenous time series data and past metadata similar to the current endogenous data and associated endogenous metadata. The historical endogenous timeseries data may be a superset of the current endogenous time series data for which a forecast is performed.

Historical exogenous data may include exogenous time series data, and exogenous alternative data may be similar to the exogenous data. The historical exogenous time series data and exogenous alternative data may be a superset of the current exogenous time series data and exogenous alternative data which is used to perform a forecast.

The data acquisition procedure 320 transmits at least the endogenous time series data to the pre-processing and feature engineering procedure 330 and to the forecasting procedure 340.

In some implementations, the data acquisition procedure 320 is configured to transmit one or more of the endogenous metadata, the exogenous time series data and the exogenous alternative data to the pre-processing and feature engineering procedure 330. It should be understood that one or more of the endogenous metadata, the exogenous time series data and the exogenous alternative data may be optional.

### Pre-Processing and Feature Engineering Procedure

The pre-processing and feature engineering procedure 330 is configured to inter alia: (i) receive endogenous data comprising endogenous time series 322 and optional metadata 324 associated therewith; and ii) generate, based on the endogenous data, a set of features 332 for informing the meta-learner 354 through the weight generation procedure.

In one or more implementations, the pre-processing and feature engineering procedure 330 is configured to receive endogenous data and exogenous data, and generate, based on the endogenous data and exogenous data, a set of features to inform the meta-learner 354 during the weight generation procedure 350. In such implementations, the exogenous data may include exogenous time series data 326, and optionally exogenous alternative data 328.

In the context of the meta-prediction procedure 300, the set of features 332 are used by the meta-learner 354 to make decisions about weights on the forecasts produced by the set of forecasting models 344 during the weight generation procedure 350. The meta-learner 354 is informed by the set of features, which are generated by the pre-processing and feature engineering procedure 330 using mathematical transformations on endogenous data and exogenous data, taken independently and/or in combination.

In one or more implementations, the pre-processing and feature engineering procedure 330 may further receive the historical endogenous time series data and historical exogenous data. The pre-processing and feature engineering procedure 330 may use the historical endogenous data and the historical exogenous data to generate the set of features.

The pre-processing and feature engineering procedure 330 may be configured to transform the data in various ways. The purpose of the pre-processing and feature engineering procedure 330 is to perform transformations on the input data to reduce noise and to extract predictive power from the time series dataset.

The pre-processing and feature engineering procedure 330 is configured to generate the set of features, which may comprise endogenous features, exogenous features or a combination thereof.

The pre-processing and feature engineering procedure 330 is configured to generate endogenous features, which involve information and transformations directly related to the time series being predicted. As a non-limiting example, the prior values of the endogenous time series over time may be used to calculate a feature.

The pre-processing and feature engineering procedure 330 is configured to generate exogenous features, which may involve either time series information not directly related to the time series data being predicted, or a mathematical relationship between exogenous time series, and the time series being predicted (i.e., the endogenous Tₑₙ). Thus, the pre-processing and feature engineering procedure 330 is configured to take into account the ecosystem context of a set of time series.

The ecosystem context may include relationships, co-integrations and other forms, including linear and non-linear forms of continuously moving relationships between time series over time.

In one or more implementations, the pre-processing and feature engineering procedure 330 is configured to inter alia to perform one or more latent space transformations to generate a latent space representation of the times series data.

In some implementations, it may be desirable to predict non-native time series, i.e., time series that are mathematical combinations of more than one time series to obtain a synthetic time series. In such implementations, it may be desirable to create a latent space with the original ecosystem of time series to obtain a new set of synthetic time series, that is potentially a reduced or an expanded set, depending on the objective, in order to perform predictions using the synthetic time series.

Latent space representation refers to a reduced-dimensionality or augmented-dimensionality form of the original time series data, generated through mathematical transformations or ML algorithms. The latent space representation captures essential patterns, trends, or features in the time series while, in some implementations, reducing the computational complexity. The latent space representations aim to encapsulate the most salient characteristics of the data to generate features.

Examples of latent space representation transformations that may be performed by the pre-processing and feature engineering procedure 330 may include one or more of: principal component analysis (PCA) vectors, autoencoder embeddings, word embeddings, topic models, t-distributed stochastic neighbor embedding (t-SNE) coordinates, latent semantic analysis (LSA) vectors, latent factors in matrix factorization, Gaussian mixture model (GMM) components, variational autoencoder (VAE) latent variables, graph embeddings, Fourier Transform coefficients, Hidden Markov Model (HMM) states, Conditional Variational Autoencoder (CVAE) latent variables, spectral clustering eigenvectors, and positional encoding in transformers.

In one or more implementations, the pre-processing and feature engineering procedure 330 is configured to perform exogenous transformations using at least one of: a time series different from the one being predicted, and a combination of more than one time series, one being the time series being predicted, and one or more other time series being different time series.

In some implementations, the pre-processing and feature engineering procedure 330 is configured to generate features including one or more of: time series metrics such as mean absolute error (MAE), root mean square error (RMSE), AIC/BIC values, residual analysis metrics, frequency domain metrics, rolling statistics, and prediction intervals; exogenous data features like economic indicators, political events, weather data, market data, social media metrics, calendar variables, and event flags; as well as meta-features like ensemble scores, feature importance, cross-validation results, historical weighting, and diversity score.

In one or more implementations, as mentioned previously, the pre-processing and feature engineering procedure 330 may generate features indicative of structural breaks, regimes and/or regime changes in time series. The pre-processing and feature engineering procedure 330 is configured to recognize and characterize level shifts including regimes and regime changes in time series data, which may be expressed as features in the set of features. In one example, a feature identified in a time series can itself be a time series that is fed into forecasting procedure 340 for forecast by one of the forecasting models 344.

In one or more implementations, the pre-processing and feature engineering procedure 330 may use various forms of description of structural breaks, such as but not limited to probabilities of various regimes found through data mining methods, a mixture of probabilities, or an indication of a most probable regime. It will be appreciated that different mathematical expressions can be defined to express regimes.

It will be appreciated that using exogenous features provides useful time series ecosystem context to the meta-learner 354 to make its weight decisions. The ecosystem context may include relationships, co-integrations and other continuously moving relationships between time series over time in a set of time series. The context may be provided using a set of time series including endogenous and exogenous time series associated with one or more given assets.

The pre-processing and feature engineering procedure 330 may generate the exogenous features using complex algorithms, including other ML models, to provide dynamically changing context, including structural breaks and regime changes, to inform the meta-learner 354 during the weight generation procedure 350.

In one or more implementations, for ecosystems of time series in a set of time series, where a given time series may impact another time series, predictive information may be found by generating features using transformations that involve multiple time series. In one or more implementations, the pre-processing and feature engineering procedure 330 is configured to subtract the time series being predicted from a reference time series to create a spread. It will be appreciated that the pre-processing and feature engineering procedure 330 may perform more complex transformations involving two or more time series, which may be useful in certain time series contexts.

As a non-limiting example, it may be desirable to predict a future value for times series TS₁, which has daily historical values. Time series TS₂ may be a different time series, but there may be reasons to believe TS₂'s behavior could affect TS₁'s behavior. In this case, transformations involving only TS₁ data are endogenous (Tₑₙ), and transformations involving only TS₂ (or other TS) data are exogenous to TS₁ (Tₑₓ). The combination of both transformations involving a relationship between TS₁ and TS₂ can also be considered exogenous because they have an exogenous element.

Thus, in one or more implementations, the pre-processing and feature engineering procedure 330 include both exogenous and endogenous features to inform the meta-learner(s) 354. In such implementations, the use of exogenous features provides useful time series ecosystem context to the meta-learner 354 to make its weight decisions. The context may include many forms such as, but not limited to, relationships between time series, correlations (i.e., linear relationships), co-integrations and other continuously moving relationships between time series over time, structural breaks, where an exogenous relationship radically changes at a given point in time, resulting in a time series regime change.

The pre-processing and feature engineering procedure 330 outputs the set of features 332. The pre-processing and feature engineering procedure 330 transmits the set of features 332 to the weight generation procedure 350.

In one or more other implementations, the pre-processing and feature engineering procedure 330 transmits the set of features 332 to the forecasting procedure 340.

In summary, pre-processing and feature engineering procedure 330 receives as a input a time series, and identifies one or more features in the time series. The pre-processing and feature engineering procedure 330 is further adapted to transform the time series, which will eventually allow the procedure 330 to identify regimes, as will be apparent hereinafter. Feature signal fₙ can be any kind of signal that is ultimately ingested by forecasting procedure 340.

### Forecasting Procedure

The forecasting procedure 340 is configured to at least: (i) receive endogenous data comprising time series data 322 and associated endogenous metadata 324; (ii) access a set of forecasting models 344; and (iii) generate, using each respective forecasting model of a set of forecasting models 344, based on the time series data, a respective forecast signal predicting at least one value.

In one or more other implementations, the forecasting procedure 340 may receive data from the pre-processing and feature engineering procedure 330 to generate the respective forecast signals.

In one or more implementations, the forecasting procedure 340 is further configured to: (iv) generate, using each respective forecasting model, a respective explainability signal associated with the respective forecast signal; and (v) generate, using each respective forecasting model, a respective forecasting attribution signal associated with the respective forecast signal, as explained hereinafter.

The forecasting procedure 340 has access to a set of forecasting models 344, which are also referred to as set of forecasting engines 344 or forecasting engine ensemble 344. At least a portion of the set of forecasting models 344 may be executed on the computing device executing the forecasting procedure 340. Alternatively, a portion of the set of forecasting models 344 may be executed on another computing device, and the outputs may transmitted to the forecasting procedure 340.

The set of forecasting models 344 comprises a plurality of (i.e., at least two) forecasting models. Each forecasting model is configured to generate a respective forecast signal or prediction based on input current time series data or features provided by the pre-processing and feature engineering procedure 330 according to a respective forecasting theme. The set of forecasting models 344 thus outputs a set of predictions in the form of a set of forecast signals. The set of forecasting models 344 may include non-ML and/or ML models.

Forecasting themes may include a wide variety of forecasting methods and associated expressions of forecast signals.

In some embodiments, the forecast signal may have a different sampling frequency than the input time series. In other embodiments, the forecast signal may be an expression of the time series that differs from its original form. For example, such forecast signal expression may be a time series showing the probability of being in a regime, or the expected regime survival rate, or even the expected regime survival period. In another embodiment, the forecast signal may describe a trend, a volatility level, a volatility range, or some other feature or mathematical transformation of the time series. In yet another embodiment, the forecast signal may be a mathematical transformation of two or more time series, resulting in a synthetic series such as one constructed by taking the difference between two time series. In other embodiments, the forecast signal may be a transformation of said synthetic time series, such as a time series expressing the probability of being in a regime, an expected regime survival rate or an expected regime survival period.

The reader will appreciate that a wide range of possibilities exist to express a forecast signal that describes a future state of a characteristic of a time series or a combination of time series.

In some implementations, a given forecasting model of the set of forecasting model 344 is configured to use respective forecasting features extracted from the time series data to generate a respective forecast signal. The respective forecasting features may be extracted from the endogenous time series data and endogenous metadata and optionally the exogenous time series data and exogenous alternative data.

The theme of a forecasting model refers to the underlying assumption, principle, or approach on which the forecasting model is based on to make predictions about future values. The theme of a forecasting model relates to the main ideas or techniques used in the model to capture patterns, trends, or relationships in the time series, and to project these patterns into the future to perform a forecast. Examples of themes for forecasting models include autoregression, moving average, seasonality decomposition, or exponential smoothing, among others. It can also include machine learning models such as decision trees or deep learning models. These models also generate their forecasts based on themes associated with their underlying architecture. For example, decision tree ensembles use rules based on the provided features, whereas deep learning models such as long-short term memory (LSTM), convolutional neural networks (CNNs) or transformer models have the ability to discover hidden characteristics in the data to drive their forecasts. In such implementations, the theme of a ML forecasting model relates to the underlying non-linear characteristics used by features by the ML forecasting model. In some embodiments, the theme of a forecasting model can ingest regimes identified by the procedure 330, or itself be adapted to identify regimes within a time series. In some embodiments, the forecasting procedure 340 will receive data that is based on different scales. In one example, the time series data can include a daily value for an asset. Procedure 330 is adapted to transform the daily value into an average weekly value; forecasting procedure 340 is adapted to ingest this data and provide a forecast signal N taking into consideration the different scales of the respective time series.

The nature of a forecast signal is not limited. A forecast signal may include one or more values predicted by a given forecasting model based on input time series data or based on a transformation of the input time series data. In one or more implementations, a forecast signal may be a real number. In one or more other implementations, a forecast signal may be a categorical value (i.e., binary or multiclass values corresponding to categories).

In one or more implementations, a forecast signal may be a prediction on a quantity of interest, over a specific period or an estimated period window in time series. In one or more implementations, a forecast signal may be a prediction of a trend, a binary signal (or ternary, etc.),

As a first non-limiting example, a forecast signal may include a price forecast over the next 10 days, which may include a point forecast at day 10, forecasts for each day in between, and/or an average forecast over a window around day 8 to 12.

As a second non-limiting example, a forecast signal may be a forecast of a prediction of weather conditions based on time series representing weather parameters (e.g., temperature, humidity, wind speed, and atmospheric pressure).

As a third non-limiting example, a forecast signal may be a prediction of electricity demand based on time series representing electricity consumption patterns.

As a fourth non-limiting example, a forecast signal may be a prediction of agricultural yields based on time series representing historical yields, and weather data.

As a fifth non-limiting example, a forecast signal may be a prediction of future outbreaks or spread of infectious diseases based on time series representing incidence or prevalence of diseases over time.

As a sixth non-limiting example, a forecast signal may be a prediction of inventory requirements based on time series representing inventory levels over time.

It will be appreciated that depending on the asset and the type of forecast signal, the set of forecasting models 344 for a current forecast signal and asset may be predetermined.

As a non-limiting example, the set of forecasting models 344 may use one or more of the following techniques: trend following, mean reversion, reversals of trend, economic data, and time series ecosystem regime-based forecasting, naïve methods, random walk with drift; seasonal naïve, theta method; automated autoregressive integrated moving average (ARIMA) algorithm; automated exponential smoothing algorithm; Trigonometric seasonality, Box-Cox transformation, ARMA errors, Trend and Seasonal components (TBATS) model; neural network time series forecasts; deep learning time series forecasts (e.g. LSTM, transformer-based architectures, etc.); decision tree-based time series forecasts (e.g. XGBoost, random forests, etc.), and the like.

Each forecasting model of the set of forecasting models 344 is associated with a specific thematic behavior. Thus, one or more forecasting models may provide more accurate predictions than remaining forecasting models, depending on the regime in the time series. As explained hereinafter, interpreting the contribution of each forecasting model to the meta-prediction (i.e., combined forecast) can provide information about the drivers of forecasts. Relating each forecaster's contribution to the total forecast indicates what the meta-learner 354 considers in terms of types of drivers for the meta-prediction.

As a non-limiting example, in the field of finance, themes may include short term trends, long term trends, driven by economic data, driven by volatility changes, driven by likelihood of reversals, driven by asset statistics, such as autoregression and the like.

In some implementations, each forecasting model of the set of forecasting models 344 is configured to output, in association with each forecast signal, at least one of: a respective explainability signal and a respective forecasting attribution signal.

The respective explainability signal is a signal that may provide explanations on how said forecast signal was obtained.

In some implementations, the respective explainability signal is generated by the interpretation and explanation procedure 400, as will be explained hereinafter with reference to FIG. 4. The explainability signals may be based on forecasting features and respective themes of the set of forecasting models 344.

In some implementations, each forecasting model of the set of forecasting models 344 is configured to output a respective forecasting attribution signal.

A forecasting attribution signal comprises prediction information that may be used to interpret the forecast signal. The forecasting attribution signal enables the construction of a wider range of interpretation signals that may be provided to a user (e.g., user 205 of client device 210). In some implementations, the forecasting attribution signals are generated by the interpretation and explanation procedure 400, as will be explained hereinafter.

It will be appreciated that the set of forecasting models 344 may be executed by one or more computing devices, may be executed in sequence and/or may be executed in parallel.

The forecasting procedure 340 outputs the respective forecast signals generated by each forecasting model of the set of forecasting models 344 to obtain a set of forecast signals.

In one or more implementations, the forecasting procedure 340 uses the set of forecasting models 344 to output a set of forecast signals 348 in the form of a forecast signal vector, where each element of the vector is a forecast signal generated by a respective one of the set of forecasting models 344.

In some implementations, the forecasting procedure 340 is configured to store the forecast signals, explainability signals, and forecasting attribution signals into the database 230.

It will be appreciated that the forecast signals, explainability signals, and forecasting attribution signals may be transmitted to other computing devices or to other procedures, as explained hereinafter.

### Weight Generation Procedure

The weight generation procedure 350, or meta-learner prediction procedure 350, is configured to inter alia: (i) access one or more meta-learner(s) 354; (ii) receive a set of features 332; and (iii) generate, using the meta-learner 354, based on the set of features 332, a set of weights 358, each respective weight being associated with a forecast signal generated by a respective one of the set of forecasting models 344.

In some implementations, the weight generation procedure 350 may receive and use input data comprising endogenous time series 322 and metadata 324 and optionally exogenous time series data 326 and exogenous alternative data 328.

The purpose of the weight generation procedure 350 is to use the trained meta-learner 354 to generate weights on the forecast signals produced by the forecasting models based on the set of features 332 from the pre-processing and feature engineering procedure 330. Since each forecasting model 344 performs under specific conditions (e.g., theme), the meta-learner 354 is configured to consider the predictive power of each forecasting model 344 in current conditions. The weight generation procedure 350 is informed by the current condition via the set of features 332.

In some implementations, as explained hereinafter, a plurality of weight generation procedures similar to the weight generation procedure 350 may be executed to generate a plurality of sets of weights (e.g., plurality of weight vectors), where each of the plurality of weight generation procedures may be executed using a respective trained meta-learner.

The weight generation procedure 350 has access to one or more meta-learners 354, also referred to as meta-learning machine learning models 354.

In other words, the meta-learner 354 leverages algorithms that are informed by the behavior of historical data and can thus modulate the weight of the forecast signals in view of historical data behavior, by assigning weights to the different forecast signals.

In some implementations, the weight generation procedure 350 may use ensemble meta-learners to weigh multiple algorithms, feature domains, forecasting domains, and ensemble methods to optimize the answer to a particular query. The ensemble meta-learners optimize the answer to specific inputs and alters weights as necessary to achieve an optimized prediction.

In one or more implementations, the weight generation procedure 350 receives the time series data from the data acquisition procedure 320, and the set of features from the pre-processing and feature engineering procedure 330. The meta-learner 354 has knowledge of the set of forecasting models 344 and respective themes used by the forecasting procedure 340. The weight generation procedure 350 uses the meta-learner 354 to generate a set of weights based on the time series data and the set of features 332. Each weight is indicative of a relative importance of a forecast signal generated by a respective forecasting model.

The trained meta-learner 354 uses the set of features 332 to inform it of behaviors affecting the time series in the input data.

In some implementations, the set of features 332 includes exogenous and endogenous features to inform the meta-learner 354.

As a non-limiting example, the meta-learner 354 may be implemented using one or more of the XGboost algorithm, Random Forest, LightGBM, CatBoost, AdaBoost, Gradient Boosting Machine (GBM), Support Vector Machines (SVM), neural network including deep neural networks, Bagging, Stacking, and Regularized Greedy Forest (RGF).

During training, the meta-learner 354 uses an objective function to minimize the error penalty on the historical meta-prediction or combination forecast, which is the weighted sum of all the historical forecast signals produced by the set of forecasting models 344. Thus, upon training, the meta-learner 354 is configured to learn an association between forecasting models 344 and the set of features.

It will be appreciated that by selecting the right type of features to characterize not only the behavior of individual time series, but also the interactions between time series within ecosystems of time series, the meta-learner 354 is configured to weight the right forecasting model for the right context.

In one or more implementations, the set of weights 358 are output as a weight vector, where each value in the weight vector corresponds to a respective weight associated with a forecast signal of a forecasting engine in a forecasting vector.

As a non-limiting example, in the context of finance, a first forecasting model may identify and forecast longer term bull/bear markets, while a second forecasting model may identify and forecast short term corrections and rallies. A third forecasting model may forecast volatility and react quickly to market stresses, while a fourth forecasting model may be driven by the asset's underlying fundamentals, such as the stock's future earnings and so on. In this context, the meta-learner 354 may determine the best combination of the forecasts to predict how the asset will behave during its target prediction window. Thus, if the meta-learner 354 weighs strongly the second forecasting model (i.e., short term forecasting), and the second forecasting model predicts a large down move, this may indicate that the short-term behavior (a correction) is likely to win over the other forecast signals. Meanwhile, the first forecasting model may still be showing an up move, however it may not be a dominant one at this time. As another non-limiting example, there may be various behaviors in a biological ecosystem, or even a climate ecosystem, where multiple interacting forces are at play, and one may be dominant over another one at a given time due to certain localized features. To illustrate this non-limiting example, in the context of weather systems, a seasonal behavior may be observed over the long run (i.e. over a year), while on a day-to-day basis, a wide range of temperatures centered around a seasonal mean may be observed. These day-to-day variations could be forecasted using a short-term forecasting model whereas a long-term model can be used to forecast the seasonal averages, and the meta-learner 354 may be used to determine the best combination of these two forecasts for a given prediction window.

The weight generation procedure 350 outputs the set of weights 358.

The weight generation procedure 350 transmits the set of weights 358 to the post-processing procedure 360.

### Combinator

In its simplest form, the meta-prediction procedure 300 includes a combinator 355, which is essentially a combination of the forecast signals N and the weight coefficient W_{N} for each signal N, and outputs what is a vector of the resulting signal F_{N}. However, as will be explained below, this signal F_{N}, while useful on its own, can be augmented through a post-processing procedure 360.

### Post-Processing Procedure

In some embodiments, the post-processing procedure 360 is fully incorporated into the combinator 355 and as mentioned above is configured to inter alia: (i) receive the set of forecast signals 348 generated by the set of forecasting models 344; (ii) receive the set of weights 358, each weight being indicative of a relative importance of a respective one of the set of forecasting models 344 in a current condition; and (iii) generate, by combining the set of weights 358 with the set of forecast signals 348, a meta-prediction 368.

The post-processing procedure 360 receives the set of forecast signals 348 generated by the forecasting procedure 340 using the set of forecasting models 344.

The post-processing procedure 360 receives the set of weights 358 generated by the weight generation procedure 350 using the trained meta-learner 354.

In one or more implementations, the post-processing procedure 360 generates the meta-prediction F_{N} 368 by performing a weighted combination of the set of weights 358 and the set of forecast signals 348.

In some implementations, the post-processing procedure 360 may also receive any one of the endogenous time series data 322 and metadata 324, exogenous time series data 326 and exogenous alternative data 328 and the set of features 332, or a combination thereof.

In some implementations, the post-processing procedure 360 may be configured to analyze the temporal trajectory of forecasts to illustrate the quality of the set of forecast signals 348 in generating the meta-prediction 368 leading a user to a greater understanding of the methodology and basis for the meta-prediction F_{N} 368.

In one or more implementations, the post-processing procedure 360 may analyze and provide an indication of one or more of: directional accuracy of forecasts and forecasting errors.

Additionally or alternatively, the post-processing procedure 360 may analyze forecast levels, to categorize the forecasts vs. actual outcomes, and perform categorical performance analysis that way. As a non-limiting example, if there are two bins, such as positive and negative values, binary classification can be done, and confusion matrix analysis can also be done (true positive (TP), false positive (FP), true negative (TN), false negative (FN)). It will be appreciated that multiclass classification may also be performed.

In one or more implementations, the post-processing procedure 360 may be connected to a web-based platform (e.g., mobile phone or app, desktop app, etc.) that includes graphical user interfaces (GUIs) to display graphically or by tabular format the various signals, such as on the client device 210 associated with the user 205.

In one or more implementations, with reference to FIG. 4 in addition to FIG. 3, the post-processing procedure 360 executes an interpretation and explanation procedure 400.

In some alternative implementations of the present technology, the interpretation and explanation procedure 400 may be optional.

In one non-limiting implementation of the present technology, an interpretation may be performed using the meta-prediction 368, without use of external data. As a non-limiting example, the meta-prediction 368 may indicate that the forecast is up (binary up), which is in itself a form of interpretation of the underlying trends of the time series.

### Explanation and Interpretation Procedure

The interpretation and explanation procedure 400 is configured to receive one or more of: (i) for each asset of the set of assets, current endogenous and exogenous data 392; (ii) historical endogenous and exogenous data 396; (iii) current forecast signals, features, weights and meta-predictions 394; and (iv) historical forecast signals, features, weights and meta-predictions 394.

It should be understood that depending on the implementations, the interpretation and explanation procedure 400 may receive only a portion of the current endogenous and exogenous data 392, historical endogenous and exogenous data 396, current forecast signals, features, weights and meta-predictions 394 and (iv) historical forecast signals, features, weights and meta-predictions 394, or any combination thereof.

The interpretation and explanation procedure 400 is then configured to generate at least one of explanations and interpretations 450 of the current meta-prediction 368.

The purpose of the interpretation and explanation procedure 400 is to inter alia: (i) perform interpretations of the meta-predictions based on set of features and group the set of features into themes that may be interpretable by human users; and (ii) perform explanations of the meta-predictions based on the set of features by providing clarity on how the meta-prediction was obtained.

In other words, the interpretation and explanation procedure 400 provides: (i) interpretability of meta-predictions and forecasts by providing an understanding of the cause of a decision leading to the meta-prediction 368 to an observer; and (ii) explainability by explaining how the forecast signals 348, the set of weights 358 and meta-predictions 368 were obtained.

In one or more implementations, the interpretation and explanation procedure 400 is configured to generate an interpretation such that the interpretation can be expressed in relatively simple text language that is easily understandable by a human, for example as opposed to statistics on hundreds or thousands of features. However, it will be appreciated that statistics on features and text may be provided in combination.

In one or more implementations, the interpretation and explanation procedure 400 is configured to perform a basic interpretation by analyzing the current set of weights 358 used by the weight generation procedure 350 (FIG. 3) and outputting the theme weight (i.e., passthrough).

The interpretation and explanation procedure 400 may perform interpretation of forecast signals by explaining how a current meta-prediction 368 was generated, using domain specific language (e.g., specialized language) or simpler language depending on the level of expertise of the user 205 or configuration parameters of the interpretation and explanation procedure 400.

As a non-limiting example, in the field of finance, a forecast may be driven 30% by economic factors, 40% by short term market technical factors, and 30% by long term financial factors.

In one or more other implementations, the interpretation and explanation procedure 400 may perform small amounts of processing and may not use historical endogenous and/or historical exogenous data.

The interpretation and explanation procedure 400 may generate interpretations that may be model wide or for a specific forecasting model to generate one or more of the interpretations and explanations 450.

In one or more implementations, the interpretation and explanation procedure 400 may use signals produced by the set of forecasting models 344 and perform transformations including signal engineering and signal processing techniques to combine and output results to create useful and user-interpretable signals.

In one or more implementations, to create useful and interpretable signals, the interpretation and explanation procedure 400 is configured to use the historical context of previous forecast signals and explanatory signals produced by the set of forecasting models 344 during the forecasting procedure 340. The interpretation and explanation procedure 400 may use historical forecast signals, historical weights, historical endogenous data and historical exogenous data acquired by the data acquisition procedure 320.

In one or more implementations, the interpretation and explanation procedure 400 may provide at least one of interpretations and explanations 450 by indicating the relative importance of the set of features used, whether these features are combined by theme or are considered stand-alone, which may for example be indicative of context, regime changes and structural breaks.

In one or more implementations, the interpretation and explanation procedure 400 may generate user-interpretable signals by generating one or more of: signals related to the forecasts of a time-series associated with an asset, signals expressed as a relative quantity to a reference, the reference being optional if an absolute forecast is sought, distribution of possible outcomes with related probabilities, conviction scores, rankings of conviction scores and forecasts and/or meta-predictions, and components of the forecast signals.

In some implementations, the interpretation and explanation procedure 400 may use all signals related to the forecast on an asset generated by the forecasting procedure 340, which may be values, percentages, binary or categorical quantities. As a non-limiting example, a forecast signal may predict that a price may increase by 2.3% of its current value, and it may be interpreted as increasing strongly (as opposed to weakly), because 2.3% is deemed an exceptional upside for that asset in the forecasting window. An example of a binary forecasting (i.e., 1 or 0), could represent up or down, or above or below the reference if the forecast is made against a non-zero reference.

In some implementations, forecast signals may be expressed as a relative quantity to a reference, where the reference may be dynamic in nature. In the field of finance, a forecast signal may be expressed as the difference between the asset's expected performance and a benchmark. As a non-limiting example, an asset price, volume or volatility may go up by 0.5% more than the equivalent quantity in the S&P 500 index. In this example, the reference may be a commonly known market benchmark (e.g., the S&P 500), or it may be calculated via a proprietary mathematical formula that relates to a specific group of assets, or a synthetic portfolio created by the user (e.g., user 205). The synthetic portfolio approach enables each user to create a plurality of signals that are unique to their particular investment style and mandate. Thus, by expressing forecast signals relative to a reference, the forecast signals may be personalized to the user 205 and, by extension, the interpretation and explanation procedure 400 may derive interpretations from the signals and the forecast signals to output explanations and interpretations 450. In such implementations, the meta-prediction procedure 300 and the interpretation and explanation procedure 400 are personalized/customized to the desired style and objectives of user(s) or group of user(s).

In one or more other implementations, forecast signals may be expressed as distributions of possible outcomes with related probabilities, across both the temporal and cross-sectional dimensions. The temporal dimension relates to historical forecast signals, while the cross-sectional dimension relates to other assets that are related, either via positive, inverse, or lack of correlation to the asset being analyzed. The temporal dimension and cross-sectional dimensions may be provided using the set of features 332 and the set of weights 358.

As a non-limiting example, in the context of finance, portfolio managers may seek to explain an asset behavior in relation to a group of assets, such as an industry or a sector. The dynamic changes between an asset and a group, such as its correlation can be inferred and interpreted, may be performed by the interpretation and explanation procedure 400.

In one or more alternative implementations, the interpretation and explanation procedure 400 executes a conviction scoring procedure 600 to obtain a set of conviction scores, which are representative of a level of trust that some expression of the forecasting will be realized. The conviction scoring procedure 600 is explained in more detail hereinafter. A conviction score represents a form of likelihood that an outcome, which may be a binary outcome, will be realized or will not be realized. The conviction score may be expressed as a number, a percentage (e.g., how likely will the outcome be realized?), or a category (e.g., low/medium/high likelihood that the outcome will be realized). It will be appreciated that the concept of the conviction score provides a level of trust that a user 205 can place on the meta-prediction.

In one or more implementations, the interpretation and explanation procedure 400 has access to one or more LLMs 356 from the set of ML models 250. The one or more LLMs 356 may be used to generate textual description based on the different categories of interpretation signals and explanation signals.

In some implementations, the interpretation and explanation procedure 400 uses the one or more LLMs 356 to interpret the feature clusters, the weight clusters (independently) and the feature-weight clusters, and then associate each of these clusters to the meta-prediction and the forecasting themes. Additionally, the one or more LLMs 294 may be used interpret the conviction score, and its stability over time and across assets.

In some implementations, the interpretation and explanation procedure 400 uses the one of more LLMs 356 to articulate the information derived from regimes and sub-regimes. This is particularly useful to a user to understand the data obtained and forecasts outputted through qualitative explanations and key statistics, all of which can be prompted and further probed using the LLMs 356. For example, the LLMs can be prompted to provide initial insights and then further probed with questions to provide more detailed information about the various forecast signals and conviction scores. These insights can, for example, include performance over time, short-term and long-term trends, as well as classical financial metrics. It will be understood that any prediction or feature or regime or trend calculated or derived from the time series data can be fed into the LLMs to provide explainability and context for any of these values.

Manually prompting LLMs 356 provides the user with an interactive environment, allowing the user to tailor the responses from the LLMs 356 more precisely. In another embodiment, the interpretation and explanation procedure 400 can include preprogrammed prompts, thereby automatically generating insights derived from the forecast signals and conviction scores, thus obviating the need for user input. A combination of pre-prompts and user prompts will also meet the objectives of the instant disclosure.

As a non-limiting example, the interpretation and explanation procedure 400 may use frameworks such as Langchain, Auto-GPT, Local Interpretable Model-Agnostic Explanations (LIME), Deep Learning Important FeaTures (DeepLIFT), SHapley Additive explanations (SHAP), TreeShap, and the like.

It will be appreciated that the interpretation and explanation procedure 400 provides, in some implementations, transparency and trust, accountability and ethics, insights and learnings, enables detecting and addressing biases of the forecasting models 344 and the meta-learner 354 during the meta-prediction procedure 300.

In some implementations, with reference to FIG. 5 in addition to FIG. 3 and FIG. 4, the interpretation and explanation procedure 400 executes a clustering procedure 500. It will be appreciated that the clustering procedure 500, or any of its components, may be optional and may not be necessarily executed in each and every implementation of the present technology.

The purpose of the clustering procedure 500 is to use one or more clustering techniques on historical data including historical endogenous and exogenous data, features, and weights to help at least one of interpretation and explanation of current meta-prediction(s) performed during the meta-prediction procedure 300.

The clustering procedure 500 may be executed at predetermined time intervals, and/or upon performing generation of meta-predictions.

### Clustering Procedure

The clustering procedure 500 is configured to inter alia: (i) receive the set of weights 492 and historical set of weights 494 generated by the meta-learner 354; (ii) receive the sets of features 496 and historical sets of features 498 used by the meta-learner 354; and (iii) generate, using at least one of: the set of weights 492 and historical set of weights 494 and the sets of features 496 and historical sets of features 498, one or more clusters to be used for explaining meta-predictions performed by the post-processing procedure 360.

In one or more implementations, the clustering procedure 500 comprises at least one of a weight clustering procedure 530 and a feature clustering procedure 540 and a cluster association procedure 560. In implementations where the clustering procedure 500 comprises a single one (i.e., one of) of the weight clustering procedure 530 and the feature clustering procedure 540, the cluster association procedure 560 may be optional or may be implemented as a pass-through.

In one or more implementations, the clustering procedure 500 is configured to receive, using the data acquisition procedure 320, forecast signals and historical forecast signals (not shown) associated with respective historical meta-learner features and respective historical sets of weights.

The clustering procedure 500 executes at least one of a weight clustering procedure 530, a feature clustering procedure 540. In some implementations, where both of the weight clustering procedure 530 and the feature clustering procedure 540 are executed, the clustering procedure 500 also executes the cluster association procedure 560.

The weight clustering procedure 530 is configured to cluster the historical weight vectors 494 to obtain historical weight clusters.

The feature clustering procedure 540 is configured to cluster the historical meta-learner features 498 to obtain historical feature clusters.

The weight clustering procedure 530 and the feature clustering procedure 540 may each use one or more clustering techniques known in the art. It will be appreciated that the weight clustering procedure 530 and the feature clustering procedure 540 may use the same or different clustering techniques. In one or more other implementations, the weight clustering procedure 540 may use dimensionality reduction techniques.

Non-limiting examples of clustering techniques or models include K-means, hierarchical clustering, DBSCAN, Gaussian mixture model (GMM), spectral clustering, affinity propagation, and agglomerative clustering. Non-limiting examples of dimensionality reduction techniques include Principal Component Analysis (PCA), t-Distributed Stochastic Neighbor Embedding (t-SNE), Linear Discriminant Analysis (LDA) and Uniform Manifold Approximation and Projection (UMAP).

In some implementations, the cluster association procedure 560 is configured to associate at least one historical weight cluster with at least one historical feature cluster to obtain an associated historical weight-feature cluster, historical weights in the historical weight-feature cluster being indicative of a relative importance of the historical features used to obtain meta-predictions.

In some embodiments, the association may be based on one or more thresholds or by using any other non-limiting technique or algorithm.

In one or more implementations, the cluster association procedure 560 is configured to use a distance metric to perform association of weight clusters and feature clusters. The distance metric may be for example based on a distance threshold or any other mathematical formulation representing a distance metric.

As a non-limiting example, there may be three clusters of forecasting vector weights, one (C1) where W1 is large, another (C2) where W2 is large, and a third one (C3) for all the other vector weights. C1 is then associated to one or a few clusters of features where there is a strong importance of those features in the model (variable importance). In this example, the intuition is that when a vector weight that falls in C1, the actual variable importance for that particular forecasting instance is known, and the historical context is also known (C1 is made up of many historical vectors that are similar to the current one), and as a group, all the historical vectors were associated with certain groups of features (clusters of features) that had an oversized influence (variable importance) over the choice of forecasting vector weights.

It will be appreciated that the weight clusters, feature clusters and weight-feature cluster associations may change over time, and the clustering procedure 500 enables dynamically grouping the features over time.

In some implementations, the features clusters may be associated with respective forecasting models of the set of forecasting models 344, where importance in the cluster properties may be extracted by the interpretation and explanation procedure 400 to augment explanations driving the weights of forecast signals from respective forecasting models.

In one or more implementations, the feature clusters, weight clusters and feature-weight clusters may be used to generate training datasets. The training datasets may be used to train one or more meta-learners 354.

In one or more implementations, with reference to FIG. 6, the post-processing procedure 360 may execute a conviction scoring procedure 600.

It should be understood that the conviction scoring procedure 600 is optional and may not be performed in each and every implementation of the present technology.

### Conviction Scoring Procedure

In one or more implementation, the conviction scoring procedure 600 is configured to, for a given asset: (i) receive current and historical meta-predictions 590; (ii) optionally receive current and historical forecast signals 592; (iii) optionally receive current and historical explainability signals 594; (iv) optionally receive current and historical explainability clusters 596; and (v) generate, for each forecast or meta-prediction, based on one or more of the current and historical forecast signals 592, current and historical meta-predictions 590, current and historical explainability signals 594, and current and historical explainability clusters, a respective conviction score C_{SN} for each forecast signal or meta-prediction.

In some implementations, the conviction scoring procedure 600 is configured to use thematic probability signals indicative of regimes via the current and historical explainability clusters 596.

The conviction scoring procedure 600 may be executed for at least one or a plurality of asset in a set of assets, and for each meta-learner of a plurality of meta-learners, in instances where a plurality of meta-learners 354 are used.

In one or more implementation, the purpose of the conviction scoring procedure 600 is to quantify the likelihood that the forecast or meta-prediction will be in the direction forecasted (positive or negative), which may be interpreted as a forecast on a forecast signal.

In one or more implementations, the conviction scoring procedure 600 may generate a conviction score for each forecast signal, in addition to or instead of the meta-prediction signal and perform a ranking procedure (not shown) to rank the forecasts and/or the meta-predictions by conviction scores, which may indicate assets that are the most likely to realize their predicted outcomes.

In one or more implementation, the conviction score metric, when used in the context of portfolio trading and ranking, provides techniques for investment managers to identify the most promising asset to invest in. The intuition is that instead of ranking on a metric that estimates the expected performance of the asset (e.g., how much the asset is expected to increase in price over a given timeframe), the conviction scoring procedure 600 ranks the forecast signals based on the conviction score, which may be interpreted as a level of trust in the forecast to realize its outcome as predicted.

In one or more other implementations, the conviction scoring procedure 600 may perform ranking using a formula that includes the conviction score and other forecasts to obtain a conviction score, which may be interpreted as a trust score, i.e., indicative of how much a user 205 can trust the forecast.

It should be noted that the conviction score is not a traditional confidence interval but may be expressed as a binary decision: either the forecast will be realized or not, in a binary fashion. In some implementations, it could be interpreted as a likelihood of that realization.

In one or more implementations, the conviction scoring procedure 600 may be performed using classifiers by generating a confusion matrix. As a non-limiting example, in a true positive scenario, the post-processing procedure 360 may have predicted a positive forecast, and a positive outcome actually happened (a true positive). Alternatively, the post-processing procedure 360 may have predicted a positive forecast but a negative outcome may have happened, resulting in a false positive. In other words, the conviction score is indicative of a likelihood that the meta-prediction will happen as predicted, thereby indicating a level of trust in the signal and the underlying model.

In one or more implementations, the conviction score is an estimate of how likely the meta-prediction procedure 300 obtains a valid direction. In one or more implementations, the conviction scoring procedure 600 provides an estimate of how much a forecast can be trusted, based on statistics produced by the meta-prediction procedure 300.

In some implementations, the statistics can be processed by an algorithm to produce the conviction score. These statistics and data may originate from any of the previously generated data, such as historical and current weights, historical and current forecasts from the set of forecasting models, historical and current features, and the like.

In one or more implementations, the conviction scoring procedure 600 provides its output to the meta-prediction selection procedure 700.

In the case where regimes have been discovered according to the teachings of the one or more implementations of the present description, the meta-learner procedure 300 can further provide a conviction score, ranking the likelihood of a direction occurring, thereby permitting a user to screen and rank regimes based on this score.

### Meta-Prediction Selection Procedure

In one or more implementations, with reference to FIG. 7, the post-processing procedure 360 may execute a meta-prediction selection procedure 700. The meta-prediction selection procedure 700 is executed after the conviction scoring procedure 600.

It should be understood that the meta-prediction selection procedure 700 is optional and may not be performed in each and every implementation of the present technology.

In one or more implementations, the meta-prediction procedure 300 may use a plurality of meta-learners 354, where each meta-learner generates a respective set of weights. Each of the respective set of weights may be used with the set of forecast signals to generate a respective meta-prediction to obtain a set of meta-predictions.

The meta-prediction selection procedure 700 aims to select the best meta-prediction as the final meta-prediction 710 in instances where a plurality of meta-predictions are generated each using a respective set of weights for the same set of forecast signals.

The meta-prediction selection procedure 700 is configured to receive a plurality of meta-predictions 692, 696 associated with respective conviction scores 694, 698.

In one or more implementations, each meta-prediction is associated with a respective conviction score (or a set of conviction scores), and the meta-prediction selection procedure 700 selects the meta-prediction associated with the highest conviction scores, which is output as the final meta-prediction 710.

In one or more other implementations, the meta-prediction selection procedure 700 may use a predictive algorithm to identify which conviction score is most stable, and thereby produce an additional layer of confidence in its selection. In such implementations, the meta-prediction selection procedure 700 may perform analysis of the stability of the conviction scores 694, 698 prior to selection.

It will be appreciated that different approaches may be used to determine stability over time, and many inputs can be used to determine stability over time, including ecosystem regime stability features, which can be translated into a machine learning problem.

In one or more implementations, the meta-prediction selection procedure 700 may execute a dynamic weighting process instead of a selection process, similar to the weight generation procedure 350 performed for the set of forecasting models 344. In such implementations, the meta-prediction selection procedure 700 may weigh each conviction score in a set of conviction scores based on its expected stability to obtain a stability-weighted combination of conviction scores, and an associated weighted meta-prediction as the final meta-prediction 710.

It will be appreciated that deep learning may be memory and computing intensive, and it may be expensive to build and operate such models. The weight generation procedure 350 using the meta-learner is relatively cheap to train and operate, especially if more traditional algorithms are used for the underlying forecasting models.

Additionally, deep learning models are also more obscure to explain and do not lend themselves to easy interpretation. Implementations of the weight generation procedure 350 using the meta-learner 354 combine the forecasts from each forecasting model in an additive way, and the meta-learner 354 may be relatively easy to explain using variable and/or forecast weight importance, while the associated meta-learner weights of forecasting models 344 can be associated with the contribution of each forecast to the overall decision.

Further, by performing implementations of the clustering procedure 500 on the meta-learner weights to create clusters of similar historical regimes, which provides a simple way for a user to interpret the model's behavior by comparing the current context with other similar historical contexts where the meta-learner output weights were similar.

### Method Description

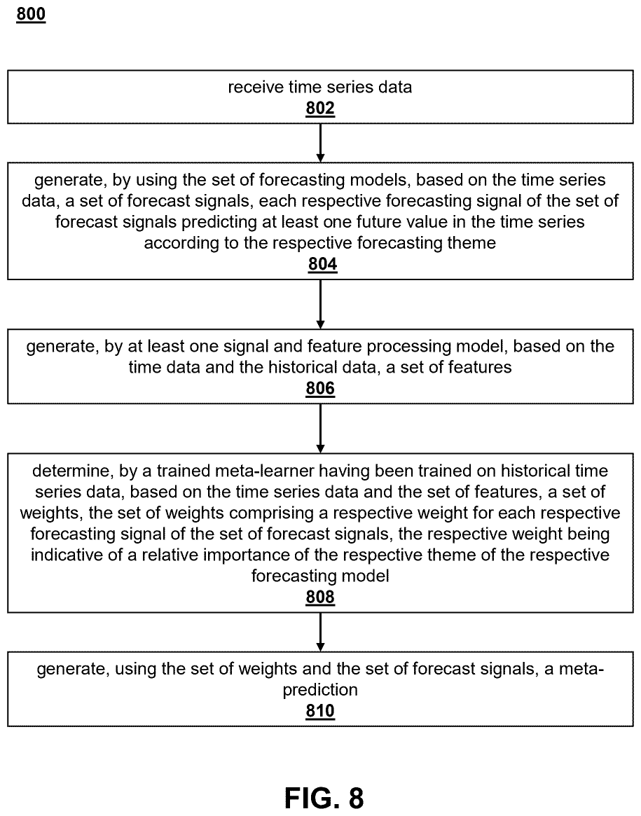

FIG. 8 depicts a flowchart of a first method 800 of generating meta-predictions in accordance with one or more non-limiting implementations of the present technology.

The first method 800 is configured to use feature engineering and signal processing techniques and models to perform meta-predictions.

In one or more implementations, the server 220 comprises at least one processor, such as the processor 110 and/or the GPU 111 operatively connected to a non-transitory computer readable storage medium such as the solid-state drive 120 and/or the random-access memory 130 storing computer-readable instructions. The at least one processor, upon executing the computer-readable instructions, is configured to or operable to execute the first method 800.

The first method 800 begins at processing step 802.

At processing step 802, the at least one processor receives, from the at least one non-transitory storage medium, time series data associated with at least one asset.

At processing step 804, the at least one processor generates, by using the set of forecasting models, based on the time series data, a set of forecast signals, each respective forecast signal of the set of forecast signals predicting at least one future value in the time series according to the respective forecasting theme.

At processing step 806, the at least one processor generates, by using at least one signal and feature processing model, based on the time series data, a set of features.

In some implementations, processing step 806 comprises applying a latent space transformation on the time series data to obtain at least a subset of the set of features. The applying the latent space transformation on the time series data to obtain at least a subset of the set of features comprises generating a synthetic time series based on the time series data and extracting at least the subset of features therefrom.

In some implementations, the time series data comprises a set of time series.

In some implementations, processing step 806 comprises determining interactions between a first time series and a second time series of the set of time series to obtain a further subset of features.

At processing step 808, the at least one processor determines by a trained meta-learner having been trained on historical time series data, based on the time series data and the set of features, a set of weights, the set of weights comprising a respective weight for each respective forecast signal of the set of forecast signals, the respective weight being indicative of a relative importance of the respective theme of the respective forecasting model.

At processing step 810, the at least one processor generates, using the set of weights and the set of forecast signals, a meta-prediction.

Although FIG. 8 shows example blocks of first method 800, in some implementations, first method 800 may include additional blocks, fewer blocks, different blocks, or differently arranged blocks than those depicted in FIG. 8. Additionally, or alternatively, two or more of the blocks of first method 800 may be performed in parallel.

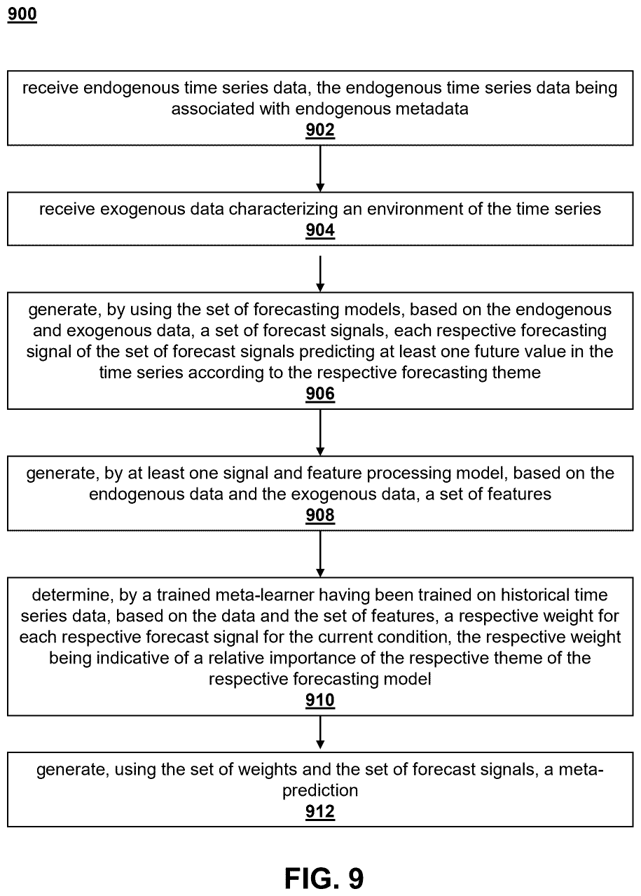

FIG. 9 is a flowchart of an example second method 900. In some implementations, one or more process blocks of FIG. 9 may be performed by the at least one processor of the computing device 100 or the server 220.

The second method 900 is configured to use exogenous data including one or more of exogenous time series and exogenous alternative data to perform a meta-predictions.

At processing step 902, the at least one processor receives, from the at least one non-transitory storage medium, endogenous time series data, the endogenous time series data being associated with endogenous metadata.

At processing step 904, the at least one processor receives, from the at least one non-transitory storage medium, exogenous data characterizing an environment of the time series data. The exogenous data comprises exogenous time series data and optionally exogenous alternative data.

At processing step 906, the at least one processor generates, by using the set of forecasting models, based on the endogenous and exogenous data, a set of forecast signals, each respective forecast signal of the set of forecast signals predicting at least one future value in the time series according to the respective forecasting theme;

At processing step 908, the at least one processor generates, by using at least one signal and feature processing model, based on the endogenous and exogenous data, a set of features.

At processing step 910, the at least one processor determines by a trained meta-learner having been trained on historical time series data, based on the endogenous time series data and the set of features, a set of weights, the set of weights comprising a respective weight for each respective forecast signal of the set of forecast signals, the respective weight being indicative of a relative importance of the respective theme of the respective forecasting model.

At processing step 912, the at least one processor generates, using the set of weights and the set of forecast signals, a meta-prediction.

Although FIG. 9 shows example blocks of second method 900, in some implementations, second method 900 may include additional blocks, fewer blocks, different blocks, or differently arranged blocks than those depicted in FIG. 9. Additionally, or alternatively, two or more of the blocks of second method 900 may be performed in parallel.

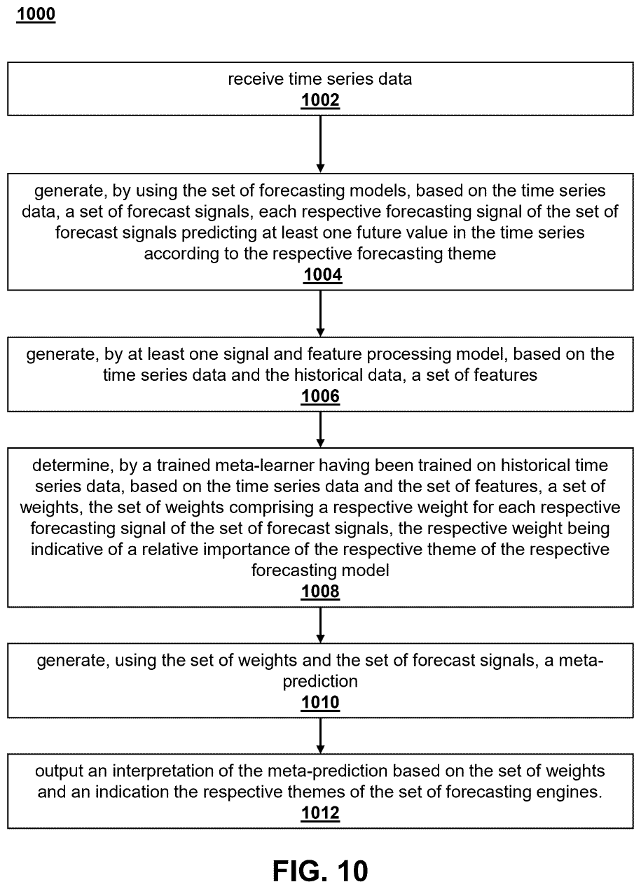

FIG. 10 is a flowchart of an example third method 1000. In some implementations, one or more process blocks of FIG. 10 may be performed by the at least one processor of the computing device 100 or the server 220.

The third method 1000 is configured to perform interpretable and/or explainable meta-predictions.

At processing step 1002, the at least one processor receives, from the at least one non-transitory storage medium, time series data.

At processing step 1004, the at least one processor generates, by using the set of forecasting models, based on the time series data, a set of forecast signals, each respective forecast signal of the set of forecast signals predicting at least one future value in the time series according to the respective forecasting theme.

At processing step 1006, the at least one processor generates, by using at least one signal and feature processing model, based on the time series data, a set of features.

At processing step 1008, the at least one processor determines by a trained meta-learner having been trained on historical time series data, based on the time series data and the set of features, a set of weights, the set of weights comprising a respective weight for each respective forecast signal of the set of forecast signals, the respective weight being indicative of a relative importance of the respective theme of the respective forecasting model.

At processing step 1010, the at least one processor generates, using the set of weights and the set of forecast signals, a meta-prediction.

At processing step 1012, the at least one processor outputs, to a client device connected to the at least one processor, an interpretation of the meta-prediction based on the set of weights and an indication of the respective themes of the set of forecasting engines.

In one or more implementations of the method, the method comprises receiving at one of: the historical forecast signals associated with respective historical features and respective historical weight vectors. The method comprises clustering the one of: historical weight vectors to obtain historical weight clusters and clustering the historical features to obtain historical feature clusters.

In one or more implementations of the method, the method further comprises: receiving historical forecast signals associated with respective historical features and respective historical weight vectors, clustering the historical weight vectors to obtain historical weight clusters, clustering the historical features to obtain historical feature clusters, associating at least one historical weight cluster with at least one historical feature cluster to obtain an associated historical weight-feature cluster, historical weights in the historical weight-feature cluster being indicative of a relative importance of the historical forecast signals, and generating, based on the associated historical weight-feature cluster, the set of forecast signals and the set of weights, a further explanation of the meta-prediction. In one or more implementations, the associating may be performed based on a threshold or by using another technique.

In one or more implementations of the method, the at least one processor generates, based on the set of forecast signals and historical forecast signals, a set of conviction scores associated with the set of forecast signals, each respective conviction score being indicative of a respective likelihood of a forecast signal being realized, and outputting, to the client device, based on the set of conviction scores, an indication of a level of trust in the meta-prediction. The set of forecast signals may be for the meta-prediction or any one of the forecast signals of the underlying forecasting engines.

In one or more implementations of the method, the at least one processor generates, using a large language model (LLM), an explanation of the meta-prediction based on at least a portion of the weight vector, the set of features, the weight clusters, the feature clusters, the weight-feature clusters, and the respective themes of the set of forecasting models.

Although FIG. 10 shows example blocks of third method 1000, in some implementations, third method 1000 may include additional blocks, fewer blocks, different blocks, or differently arranged blocks than those depicted in FIG. 10. Additionally, or alternatively, two or more of the blocks of third method 1000 may be performed in parallel.

It should be expressly understood that not all technical effects mentioned herein need to be enjoyed in each and every implementation of the present technology. For example, implementations of the present technology may be implemented without the user enjoying some of these technical effects, while other non-limiting implementations may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

What is claimed is:

1. A method for performing a meta-prediction of at least one time series by using a set of forecasting models, each forecasting model being associated with a respective forecasting theme, the method being executed by at least one processor operatively connected to at least one non-transitory storage medium, the at least one processor having access to the set of forecasting models, the method comprising:
receiving, from the at least one non-transitory storage medium, at least one time series data;
generating, by using the set of forecasting models, based on each of the at least one time series data, a set of forecast signals, each respective forecast signal of the set of forecast signals predicting at least one future value derived from the time series according to the respective forecasting theme;
generating, by at least one signal and feature processing model, based on the time series data, a set of features;
determining, by a trained meta-learner on historical time series data, based on the time series data and the set of features, a set of weights, the set of weights comprising a respective weight for each respective forecast signal of the set of forecast signals, the respective weight being indicative of a relative importance of the respective theme of the respective forecasting model; and
generating, using the set of weights and the set of forecast signals, a meta-prediction for the time series data.

2. The method of claim 1, wherein said at least one time series includes a plurality of time series, and wherein each forecasting model of the set of forecasting models receives a different time series.

3. The method of claim 1, wherein said at least one time series includes a transformed time series.

4. The method of claim 1, wherein said generating, by at least one signal and feature processing model, based on the time series data, the set of features includes applying a latent space transformation on the time series data to obtain at least a subset of the set of features.

5. The method of claim 4, wherein said applying the latent space transformation on the time series data to obtain at least the subset of the set of features comprises generating a synthetic time series based on the time series data and extracting at least the subset of features therefrom.

6. The method of claim 2, wherein
one of said at least one time series data comprises a set of time series; and
wherein
said generating, by the at least one signal and feature processing model, based on the time series data, the set of features comprises:
determining interactions between at least a first time series and a second time series of the set of time series to obtain a further subset of features.

7. A method according to claim 1, wherein said at least one future value includes a fixed value, a tendency, a binary value and a combination thereof.

8. A method for performing a meta-prediction of time series by using a set of forecasting models, each forecasting model being associated with a respective forecasting theme, the method being executed by at least one processor operatively connected to at least one non-transitory storage medium, the at least one processor having access to the set of forecasting models, the method comprising:
receiving, from the at least one non-transitory storage medium, endogenous data comprising endogenous time series data associated with endogenous metadata;
receiving, from the at least one non-transitory storage medium, exogenous data characterizing an environment of the time series;
generating, by using the set of forecasting models, based on the endogenous and exogenous data, a set of forecast signals, each respective forecast signal of the set of forecast signals predicting at least one future value in the time series according to the respective forecasting theme;
generating, by at least one signal and feature processing model, based on the endogenous data and the exogenous data, a set of features;
determining, by a trained meta-learner on historical time series data, based on the endogenous time series data and the set of features, a respective weight for each respective forecast signal, the respective weight being indicative of a relative importance of the respective theme of the respective forecasting model; and
generating, using the set of weights and the set of forecast signals, a meta-prediction.

9. The method of claim 8, wherein the exogenous data comprises exogenous time series data and exogenous alternative data representative of the environment of the time series data.

10. The method of claim 8, wherein said generating, by the at least one signal and feature processing model, based on the endogenous data and the exogenous data, the set of features comprises at least one of:
generating a first subset of features indicative of regime changes in the endogenous time series data,
generating a second subset of features by performing a latent space representation transformation of the endogenous time series data, and
generating a third subset of features by performing a transformation based on the endogenous data and the exogenous data.

11. The method of claim 10, wherein said generating, by the at least one signal and feature processing model, based on the endogenous data and the exogenous data, the third subset of set of features comprises determining at least one of correlations, co-integrations and conditional relationships between the endogenous time series data and the exogenous time series data.

12. A method for performing a meta-prediction of time series by using a set of forecasting models, each forecasting model being associated with a respective forecasting theme, the method being executed by at least one processor operatively connected to at least one non-transitory storage medium, the at least one processor having access to the set of forecasting models, the method comprising:
receiving, from the at least one non-transitory storage medium, time series data;
generating, by using the set of forecasting models, based on the time series data, a set of forecast signals, each respective forecast signal of the set of forecast signals predicting at least one future value in the time series according to the respective forecasting theme;
generating, by at least one signal and feature processing model, based on the time series data, a set of features;
determining, by a trained meta-learner on historical time series data, based on the time series data and the set of features, a set of weights, the set of weights comprising a respective weight for each respective forecast signal of the set of forecast signals, the respective weight being indicative of a relative importance of the respective theme of the respective forecasting model;
generating, using the set of weights and the set of forecast signals, a meta-prediction; and
outputting, to a client device, at least one of an interpretation and an explanation of the meta-prediction based on the set of weights and an indication of the respective themes of the set of forecasting engines.

13. The method of claim 12, further comprising, generating the at least one of the interpretation and the explanation of the meta-prediction by performing at least one of:
generating an interpretation signal based on the forecast signals relative to a reference forecast,
expressing context related to a regime signal discovered by at least one unsupervised learning algorithm,
expressing the set of forecast signals relative to a respective reference value, and
determining a distribution of possible outcomes associated with respective probabilities based on historical forecast signals.

14. The method of claim 13, further comprising:
receiving historical forecast signals associated with respective historical features and respective historical weight vectors;
clustering the historical weight vectors to obtain historical weight clusters;
clustering the historical features to obtain historical feature clusters;
associating at least one historical weight cluster with at least one historical feature cluster to obtain an associated historical weight-feature cluster, historical weights in the historical weight-feature cluster being indicative of a relative importance of the historical forecast signals; and
generating, based: on the associated historical weight-feature cluster, the set of forecast signals and the set of weights, at least one of a further explanation and a further interpretation of the meta-prediction.

15. The method of claim 13, further comprising:
providing at least one of said at least one time series to an unsupervised machine learning algorithm to discover regimes in said time series
generating, based on at least one regime, the set of forecast signals and the set of weights, at least one of a further explanation and a further interpretation of the meta-prediction.

16. The method of claim 12, further comprising
generating, based on the set of forecast signals and historical forecast signals, a set of conviction scores associated with at least one of the set of forecast signals and the meta-prediction, each respective conviction score being indicative of a respective likelihood of a forecast signal being realized; and
outputting, to the client device, based on the set of conviction scores, an indication of a level of trust in the meta-prediction.

17. The method of claim 12, further comprising: generating, using a large language model (LLM), an explanation of the meta-prediction based on the weight vector, the set of features, and the respective themes of the set of forecasting models.

18. A system for performing a meta-prediction of time series by using a set of forecasting models, each forecasting model being associated with a respective forecasting theme, the system comprising:
at least one non-transitory storage medium storing computer-readable instructions thereon; and
at least one processor operatively connected to at least one non-transitory storage medium, the at least one processor having access to the set of forecasting models,
the at least one processor, upon executing the computer-readable instructions, being configured for:
receiving, from the at least one non-transitory storage medium, time series data;
generating, by using the set of forecasting models, based on the time series data, a set of forecast signals, each respective forecast signal of the set of forecast signals predicting at least one future value in the time series according to the respective forecasting theme;
generating, by at least one signal and feature processing model, based on the time series data, a set of features;
determining, by a trained meta-learner having been trained on historical time series data, based on the time series data and the set of features, a set of weights, the set of weights comprising a respective weight for each respective forecast signal of the set of forecast signals, the respective weight being indicative of a relative importance of the respective theme of the respective forecasting model; and
generating, using the set of weights and the set of forecast signals, a meta-prediction.

19. The system of claim 18, wherein said generating, by at least one signal and feature processing model, based on the time series data, the set of features comprises: applying a latent space transformation on the time series data to obtain at least a subset of the set of features.

20. The system of claim 19, wherein said applying the latent space transformation on the time series data to obtain at least the subset of the set of features comprises generating a synthetic time series based on the time series data and extracting at least the subset of features therefrom.

21. The system of claim 19, wherein
the time series data comprises a set of time series; and wherein
said generating, by the at least one signal and feature processing model, based on the time series data, the set of features comprises:
determining interactions between a first time series and a second time series of the set of time series to obtain a further subset of features.

22. The system of claim 18, wherein said at least one processor is further configured to generate, by an unsupervised machine learning module, at least two regimes expressing behavioral characteristics of said at least one time series.

23. A system for performing a meta-prediction of at least one time series by using a set of forecasting models, each forecasting model being associated with a respective forecasting theme, the system comprising:
at least one non-transitory storage medium storing computer-readable instructions thereon; and
at least one processor operatively connected to at least one non-transitory storage medium, the at least one processor having access to the set of forecasting models,
the at least one processor, upon executing the computer-readable instructions, being configured for:
receiving, from the at least one non-transitory storage medium, endogenous data comprising endogenous time series data associated with endogenous metadata;
receiving, from the at least one non-transitory storage medium, exogenous data characterizing an environment of the endogenous time series data;
generating, by using the set of forecasting models, based on the endogenous and exogenous data, a set of forecast signals, each respective forecast signal of the set of forecast signals predicting at least one future value in the time series according to the respective forecasting theme;
generating, by at least one signal and feature processing model, based on the endogenous data and the exogenous data, a set of features;
determining, by a trained meta-learner having been trained on historical time series data, based on the endogenous time series data and the set of features, a respective weight for each respective forecast signal, the respective weight being indicative of a relative importance of the respective theme of the respective forecasting model; and
generating, using the set of weights and the set of forecast signals, a meta-prediction.

24. The system of claim 23, wherein the exogenous data comprises exogenous time series data and exogenous alternative data representative of the environment of the endogenous time series data.

25. The system of claim 23, wherein said generating, by the at least one signal and feature processing model, based on the endogenous data and the exogenous data, the set of features comprises at least one of:
generating a first subset of features potentially indicative of regime changes in the endogenous time series data,
generating a second subset of features by performing a latent space representation transformation of the endogenous time series data, and
generating a third subset of features by performing a transformation based on the endogenous data and the exogenous data.

26. The system of claim 25, wherein said generating, by the at least one signal and feature processing model, based on the endogenous data and the exogenous data, the set of features comprises: determining correlations, co-integrations and/or further conditional relationships between the endogenous time series data and the exogenous time series data.

27. A system for performing a meta-prediction of time series by using a set of forecasting models, each forecasting model being associated with a respective forecasting theme, the system comprising:
at least one non-transitory storage medium storing computer-readable instructions thereon; and
at least one processor operatively connected to at least one non-transitory storage medium, the at least one processor having access to the set of forecasting models,
the at least one processor, upon executing the computer-readable instructions, being configured for:
receiving, from the at least one non-transitory storage medium, time series data;
generating, by using the set of forecasting models, based on the time series data, a set of forecast signals, each respective forecast signal of the set of forecast signals predicting at least one future value in the time series according to the respective forecasting theme;
generating, by at least one signal and feature processing model, based on the time series data, a set of features;
determining, by a trained meta-learner having been trained on historical time series data, based on the time series data and the set of features, a set of weights, the set of weights comprising a respective weight for each respective forecast signal of the set of forecast signals, the respective weight being indicative of a relative importance of the respective theme of the respective forecasting model;
generating, using the set of weights and the set of forecast signals, a meta-prediction; and
outputting, to a client device, at least one of an interpretation and an explanation of the meta-prediction based on the set of weights and an indication of the respective themes of the set of forecasting engines.

28. The system of claim 27, wherein the at least one processor is further configured for, generating the at least one of the interpretation and the explanation of the meta-prediction by performing at least one of:
generating an interpretation signal based on the forecast signals relative to a reference forecast,
expressing the set of forecast signals relative to a respective reference value, and
determining a distribution of possible outcomes associated with respective probabilities based on historical forecast signals.

29. The system of claim 27, wherein the at least one processor is further configured for:
receiving previously forecast signals associated with respective historical features and respective previously calculated weight vectors;
clustering the previously calculated weight vectors to obtain historical weight clusters;
clustering the historical features to obtain historical feature clusters;
associating at least one historical weight cluster with at least one historical feature cluster to obtain an associated historical weight-feature cluster, historical weights in the historical weight-feature cluster being indicative of a relative importance of the historical forecast signals; and
generating, based: on the associated historical weight-feature cluster, the set of forecast signals and the set of weights, a further explanation of the meta-prediction.

30. The system of claim 27, wherein the at least one processor is further configured for:
generating, based on the set of forecast signals and historical forecast signals, a set of conviction scores associated with at least one of the meta-prediction and the set of forecast signals, each respective conviction score being indicative of a respective likelihood of a forecast signal being realized; and
outputting, to the client device, based on the set of conviction scores, an indication of a level of trust in the meta-prediction.

31. The system of claim 26, wherein the at least one processor is further configured for: generating, using a large language model (LLM), an explanation of the meta-prediction based on the weight vector, the set of features, and the respective themes of the set of forecasting models.

32. A system for performing a meta-prediction of at least one time series by using a set of forecasting models, each forecasting model being associated with a respective forecasting theme, the system comprising:
at least one non-transitory storage medium storing computer-readable instructions thereon; and
at least one processor operatively connected to at least one non-transitory storage medium, the at least one processor having access to the set of forecasting models,
the at least one processor, upon executing the computer-readable instructions, being configured for:
receiving, from the at least one non-transitory storage medium, endogenous data comprising endogenous time series data associated with endogenous metadata;
receiving, from the at least one non-transitory storage medium, exogenous data characterizing an environment of the endogenous time series data;
generating, by using the set of forecasting models, based on the endogenous and exogenous data, a set of forecast signals, each respective forecast signal of the set of forecast signals predicting at least one future value in the time series according to the respective forecasting theme;
generating, by at least one signal and feature processing model, based on the endogenous data and the exogenous data, a set of features;
generating, by an unsupervised machine learning module, at least two regimes expressing behavioral characteristics of said at least one time series;
determining, by a trained meta-learner having been trained on historical time series data, based on the endogenous time series data and the set of features, a respective weight for each respective forecast signal, the respective weight being indicative of a relative importance of the respective theme of the respective forecasting model;
generating, using the set of weights and the set of forecast signals, a meta-prediction, said meta-prediction being further conditioned by identifying a probability that said time series is in a regime of said at least two regimes.

33. A system according to claim 32, wherein said at least two regimes represent contextual information relating to the time series.

34. A system according to claim 33, wherein said contextual information is graphically illustrated on a graph identifying each of the at least two regimes of the time series, and a probability that the time series is currently in one or another of the at least two regimes.

35. A system according to claim 32, wherein said system is adapted to:
generating, based on the set of forecast signals, historical forecast signals and said at least two regimes, a set of conviction scores associated with at least one of the meta-prediction and the set of forecast signals, each respective conviction score being indicative of a respective likelihood of a forecast signal being realized; and
outputting, to the client device, based on the set of conviction scores, an indication of a level of trust in the meta-prediction.

36. A system according to claim 32, wherein each of said regimes is assigned a regime score, said regime score being based at least in part on performance characteristics of each of said regimes.

37. A system according to claim 27, wherein:
said system is further adapted to generate, by an unsupervised machine learning module, at least two regimes expressing behavioral characteristics of said at least one time series; and
said meta-prediction being further conditioned by identifying a probability that said time series is in a regime of said at least two regimes.
